(19) United States
(12) Patent Application Publication
(10) Pub. No.: US 2026/0348311 A1
(43) Pub. Date: Nov. 5, 2026

(54) Engine Dehumidification System and Method

(71) Applicant: Advanced Product Consulting, LLC, Brighton, MI (US)

(72) Inventor: Joseph S. Miskovich, Fenton, MI (US)

(21) Appl. No.: 19/654,892

(22) Filed: Apr. 22, 2026

Related U.S. Application Data
(60) Provisional application No. 63/797,586, filed on Apr. 30, 2025.

(51) Int. Cl. F01M 13/02; F01M 11/10; F01M 13/04; F02M 25/03

(52) U.S. Cl. CPC F01M 13/028; F01M 11/10; F01M 13/04; F02M 25/03; F01M 2013/0438

(57) ABSTRACT

A sealed dehumidification system and method for removing humidity from an interior of an internal combustion engine at rest. The system includes a dehydrator including a dryer cartridge. At least one fan draws humid air through an oil breather pipe of the internal combustion engine, through an air inlet tube, into the dehydrator, and through the dryer cartridge. The dryer cartridge removes humidity from the humid air and the at least one fan transfers dehumidified air received from the dryer cartridge through an air outlet tube to the oil filler port and the exhaust pipe of the IC engine to circulate dehumidified air in the interior of the IC engine. Humid air is returned to the dehydrator through the air inlet tube by the at least one fan.

### CROSS-REFEENCE TO RELATED APPLICATIONS

This US utility patent application claims priority benefit to US Provisional Patent Application No. 63/797,568 filed Apr. 30, 2025, the contents of which is incorporated herein by reference in the entirety and for all purposes.

### TECHNICAL FIELD

The present disclosure relates generally to the field of the preservation of internal combustion engines and preventative maintenance thereof.

### BACKGROUND

Internal combustion engines generate a significant amount of heat during operation due to the ignition and combustion of fuel. A byproduct of fuel combustion is water or moisture in gaseous form in the interior of the engine. When the engine stops running and is in a state of rest, the hot internal components of the engine begin to cool which can generate water vapor in internal spaces and condensation on the surfaces of the interior components. Even modern engine components are often made of steel or cast iron which can begin to form rust on these surfaces and over time, require expensive repairs or replacement of the corroded engine components.

Internal combustion engines for aircraft are equally, if not more, susceptible to moisture generation and corrosion of internal components versus, for example, internal combustion engines used in automotive vehicles which employ different cooling systems and other devices and systems for treatment of the exhaust gases.

Prior devices for dehumidifying or dehydrating, i.e., removing humidity, from internal combustion engines for aircraft have significant limitations and disadvantages. For example, some prior devices continually draw ambient air from the surrounding environment which may already have a high level of humidity. Other devices are significantly limited in properly circulating air to all of the vital internal areas and components of the engine.

It would be beneficial for an engine dehumidification device and method which eliminates or improves on these disadvantages.

### SUMMARY

The present invention includes a sealable, or sealed dehumidification system and method for removing humidity from an interior of an internal combustion engine (IC engine) at rest (i.e., the IC engine is not running or operating).

In one example, the system includes a dehydrator including a case defining an interior. The case having an air inlet and an air outlet defining an air pathway through the interior of the case between the air inlet and the air outlet. A dryer cartridge is positioned in the interior of the case in communication with the air pathway and is configured to remove the humidity from humid air in the air pathway. At least one fan having a fan speed is in communication with the air pathway. The system includes an air inlet tube configured to sealingly connect to an oil breather pipe of the IC engine and to sealingly connect to the air inlet of the case. The system further includes an air outlet tube configured to sealingly connect to the air outlet of the case and to sealingly connect to an oil filler port and an exhaust pipe of the IC engine. In operation, the at least one fan is configured to draw the humid air from the IC engine through the oil breather pipe, through the inlet tube, through the air inlet of the case, into the air pathway in the interior of the case and through the dryer cartridge. The at least one fan is configured to force dehumidified air received from the dryer cartridge through the air outlet of the case, through the air outlet tube, to the oil filler port and the exhaust pipe of the IC engine forming the sealed dehumidification system wherein ambient air is prevented from being drawn into the dehydrator from an environment surrounding the dehydrator.

In one example of the system, an oil filler fitting is used to sealingly connect the air outlet tube to the oil filler port of the IC engine. In another example, an exhaust fitting is used to sealingly connect the air outlet tube to the exhaust pipe of the IC engine. In another example, an oil breather pipe fitting is used to sealingly connect the air inlet tube to the oil breather pipe of the IC engine.

In an alternate example, a sealed engine dehumidification system for removing humidity from an interior of an internal combustion engine (IC engine) of an aircraft at rest is provided. The system includes a dehydrator including a case defining an interior and having an air inlet and an air outlet defining an air pathway through the interior of the case between the air inlet and the air outlet. A dryer cartridge is positioned in the interior of the case in communication with the air pathway and is configured to remove the humidity from humid air in the air pathway and exit dehumidified air from the dryer cartridge. A first fan having a fan speed is positioned in the interior of the case upstream of the dryer cartridge and in communication with the air pathway and a second fan having a fan speed is positioned in the interior of the case downstream of the dryer cartridge and in communication with the air pathway.

The alternate system example further includes an air inlet tube configured to sealingly connect to an oil breather pipe of the IC engine and to sealingly connect to the air inlet of the case. An air outlet tube is configured to sealingly connect to the air outlet of the case and to sealingly connect to an oil filler port and an exhaust pipe of the IC engine. An oil filler fitting is used and configured to sealing connect to the oil filler port and the air outlet tube. The oil filler fitting includes a constrictor configured to increase a velocity of the dehumidified air received from the dehydrator, and an elongate down tube extending proximate to a reservoir oil level in an oil sump of the IC engine and is configured to transfer the dehumidified air directly to the oil sump of the IC engine. An exhaust fitting is used and configured to sealingly connect to the air outlet tube and to sealingly engage the exhaust pipe, the exhaust fitting including a constrictor configured to increase a velocity of the dehumidified air received from the dehydrator. An oil breather pipe fitting is used and configured to sealingly connect to the air inlet tube and sealing engage the oil breather pipe of the IC engine. The oil breather pipe fitting includes a bottle configured to receive and store liquid oil received from the IC engine through the oil breather pipe. The oil breather pipe fitting is configured to transfer humid air from the interior of the IC engine to the dehydrator while preventing ambient air from being drawn into the dehydrator from an environment surrounding the dehydrator.

In operation, the alternate example system first fan and the second fan are configured to draw the humid air from the interior of the IC engine through the oil breather pipe, through the inlet tube, through the air inlet of the case, into the air pathway in the interior of the case and through the dryer cartridge. The first fan and the second fan force the dehumidified air received from the dryer cartridge through the air outlet of the case, through the air outlet tube, through the oil filler fitting and the oil filler port, and through the exhaust pipe fitting and the exhaust pipe, of the IC engine forming the sealed dehumidification system wherein the ambient air is prevented from being drawn into the dehydrator from the environment surrounding the dehydrator.

In one example of the invention, a method of dehumidifying an interior of an internal combustion engine (IC engine) at rest is provided. The method includes sealingly connecting an air inlet tube to an oil breather pipe of the IC engine and sealingly connecting the air inlet tube to an air inlet of a dehydrator. The method further includes sealingly connecting an air outlet tube to an oil filler port of the IC engine, an exhaust pipe of the IC engine, and to an air outlet of the dehydrator. The method includes forcibly drawing humid air by at least one fan connected to the hydrator from the interior of the IC engine through the air inlet tube into an interior of the dehydrator preventing ambient air from an environment surrounding the dehydrator from entering the dehydrator.

The method further includes transferring by the at least one fan the humid air along an air pathway in the interior of the dehydrator though a dryer cartridge. The method further includes removing humidity from the humid air passing through the dryer cartridge and exiting dehumidified air along the air pathway through the air outlet of the dehydrator, and transferring by the at least one fan the dehumidified air through the air outlet tube to the interior of the IC engine through the oil filler port and the exhaust pipe.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a highly schematic cut-away front view illustration of one example of a horizontal-configured aircraft internal combustion engine connected to one example of the sealed dehumidification system of the present invention.

FIG. 2 is a highly schematic top view of one example of a horizontally-configured aircraft internal combustion engine connected to one example of the sealed dehumidification system of the present invention.

FIG. 3 is a schematic perspective view of one example of the sealed dehumidification system.

FIG. 4 is a perspective view of one example of a dehydrator device with a dryer cartridge installed.

FIG. 5 is an alternate perspective view of the dehydrator device in FIG. 4 without a dryer cartridge installed.

FIG. 6 is a partially cut-away, perspective view of one example of a dryer cartridge.

FIG. 7 is a front view of one example of a display panel.

FIG. 8 is a perspective view of one example of an oil filler fitting.

FIG. 9 is a partial cross-sectional view taken along line 9-9 in FIG. 8.

FIG. 10A is a perspective view of one example of an exhaust fitting installed on an exhaust pipe.

FIG. 10B is a cross-sectional perspective view taken along line 10B-10B in FIG. 10A.

FIG. 11 is a cross-sectional view of an alternate example of an exhaust fitting.

FIG. 12 is a front view of one example of an oil breather pipe fitting.

FIG. 13A is a cross-sectional view of one example of an oil breather pipe fitting taken along line 13A-13A in FIG. 12.

FIG. 13B is a cross-sectional view of another example of an oil breather pipe fitting positioned in a vertical orientation.

FIG. 14 is a perspective view of one example of an oil particulate filter.

FIG. 15 is a perspective view of one example of a clip shown in a closed position.

FIG. 16 is a left side view of the clip of FIG. 15 shown in an open position.

FIG. 17 is a schematic view of one example of the sealed dehumidification system configured for a purge cycle.

FIG. 18 schematic perspective view of one example of a purge dryer filter.

FIG. 19 is a flow chart of one example of a method of use of the sealed dehumidification system of the present invention.

FIG. 20 is a flow chart of one example of a method of use of the sealed dehumidification system configured for a purge cycle.

FIG. 21 is a flow chart of one example of a method of operation of the sealed dehumidification system of the present invention.

### DETAILED DESCRIPTION

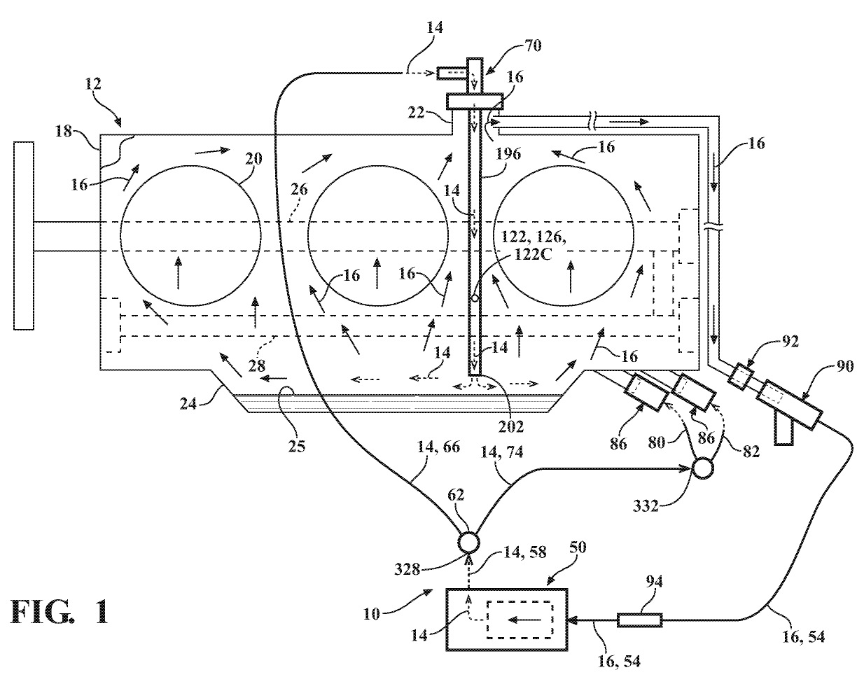

The present invention as shown in FIGS. 1-21 is a sealed dehumidification system and method for removing humidity from an internal combustion engine, IC engine 12, at rest (i.e., the IC engine not running or operating). The system 10 and the methods 400, 600, 700, and other variations or configurations described or illustrated herein, are particularly, but not exclusively, useful for piston-type aircraft engines, but may be used on other internal combustion engines, for example, automotive vehicles (including, but not limited to, older model vehicles), motor cycles, mopeds, watercraft (e.g., boats, jet skis), industrial equipment (e.g., generators) and other vehicles and devices utilizing IC engines. In an alternate application and/or configuration, the sealed dehumidification system may be used in office, home or residential equipment that benefit from monitoring and lowering the humidity in an interior of the equipment.

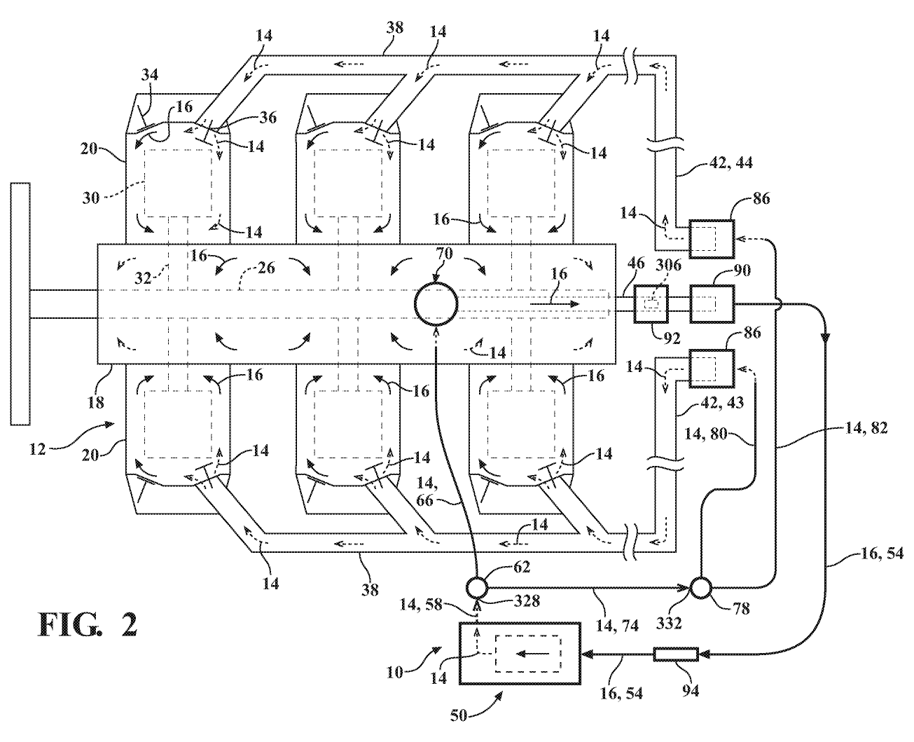

Referring to FIGS. 1 and 2, an example of the system 10 is used with an IC engine 12 for an aircraft. In the example, IC engine 12 is a horizontal six cylinder piston-type engine. As described in detail below and in the illustrations, system 10 circulates dehumidified air 14 (i.e., air wherein the humidity has been reduced relative to the upstream interior of the IC engine)(shown as dashed arrows) into an interior of the IC engine 12 and returns the humid air 16 (shown as solid line arrows) from the interior of the IC engine 12 to a dehydrator to remove humidity from the humid air received from the interior of the IC engine for return back to the IC engine 12. In the system 10 example, the system 10 is a sealable or sealed system that prevents, or substantially prevents, ambient air from continually being drawn into a dehydrator from an environment immediately surrounding the dehydrator as further described below. The example system 10 may also be considered a closed-loop system from the perspective that when the system 10 is in operation, air is continually circulated from a dehydrator (described further below) to the IC engine 12, and back to the dehydrator wherein the humid air received from the interior of the IC engine is dehumidified and then returned to the IC engine 12 as described above and further below. The system 10 when installed or connected to the IC engine 12 also forms a sealed system in that ambient air is prevented from being drawn into the dehydrator from an environment (e.g., air) surrounding the dehydrator.

In the example, the IC engine 12 includes a cylinder block 18 including cylinders 20 (six shown in FIG. 2), and an oil filler port 22 wherein engine lubrication oil may be added to the engine for lubrication of internal components. In the example, an oil sump 24 is positioned toward the bottom of the IC engine 12 serving as a reservoir of oil having a reservoir oil level 25 as best seen in FIG. 1. The IC engine 12 example includes a crankshaft 26 and a camshaft 28. Pistons 30 are positioned within cylinders 20, respectively, and are connected to the crankshaft 26 by respective connecting rods 32 as generally shown. In normal operation of the IC engine 12 in the simplified schematic example, each cylinder 20 includes an intake valve 34 and an exhaust valve 36 in communication with the camshaft 28 to control the intake of fuel into each cylinder 20 and the exhaust exiting each cylinder 20 following combustion of the fuel in a manner generally known by persons skilled in the art.

In the example, each exhaust valve 36 is in communication with an exhaust manifold 38 (two shown in FIG. 2) that is in communication with an exhaust pipe 42. In the FIGS. 1 and 2 example, a first exhaust pipe 43 and a second exhaust pipe 44 are shown. In the IC engine 12 example in the form of an aircraft engine, an oil breather pipe 46 is in communication with an oil filler port 22 and the interior of the IC engine 12 as generally known by persons skilled in the art.

It is understood that IC engine 12 can take other forms and configurations and include additional or alternative components than the simplified and highly schematic example shown in FIGS. 1 and 2. By way of example only, the IC engine 12 can have a different configuration and a different number of cylinders 20 and accompanying pistons 30, a different configuration and number of valves, an alternate location and orientation of the crankshaft 26, an alternate number and location of the camshaft 28, an exhaust manifold 38 with an alternate configuration, an alternate number and location of the exhaust pipe 42, and alternate configurations of the oil filler port 22, the oil breather pipe 46, the oil sump, and other components than as illustrated in FIGS. 1 and 2.

Referring to the FIGS. 1, 2 and 3 example of system 10, and described in further detail below, system 10 includes a dehydrator 50, an air inlet tube 54, an air outlet tube 58, a first valve 62, and a first air outlet tube 66 connected to an oil filler fitting 70. The example further includes a second air outlet tube 74, a second valve 78, a first exhaust outlet tube 80 and a second exhaust outlet tube 82 each connected to an exhaust fitting 86 as generally shown. The system 10 example further includes an oil breather pipe fitting 90 connecting to the air inlet tube 54, a clip 92 for use to seal or close an ice hole in the oil breather pipe 46, and an oil particulate filter 94 as further described and illustrated below.

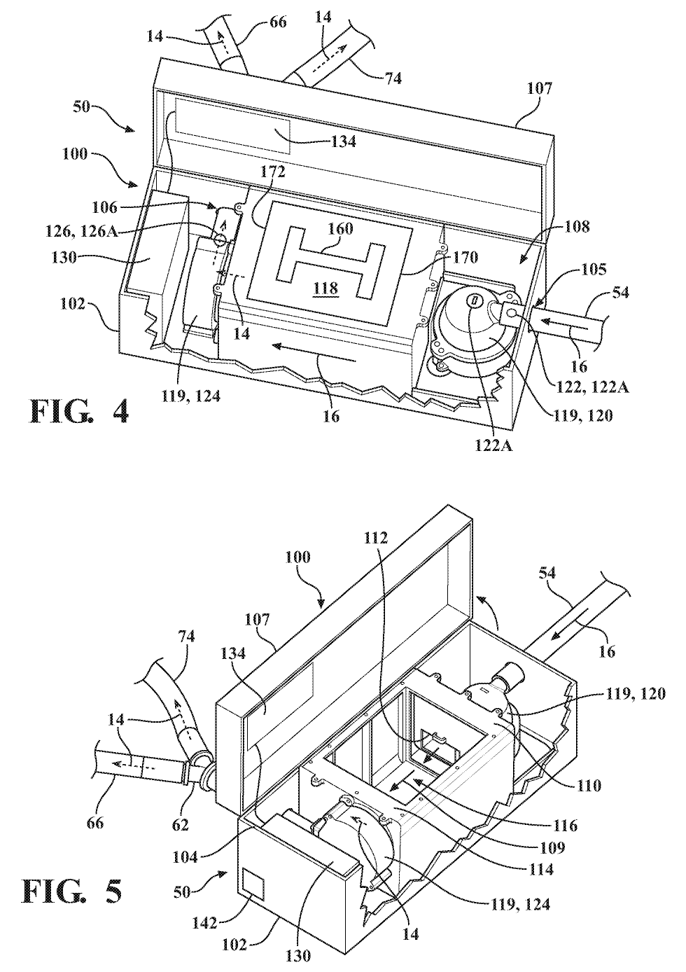

Referring to FIGS. 4 and 5, an example of a dehydrator 50 for use in the system 10 is shown. In one example, the dehydrator 50 is configured to remove humidity (i.e., water vapor) in the humid air 16 drawn from or received from the interior of the IC engine 12. In the example, the dehydrator 50 includes a case 100 defining an interior 108 having an air inlet 105 and an air outlet 106 defining an air pathway 109 through the interior 108 of the case 100 between the air inlet 105 and the air outlet 106.

In the example as best seen in FIG. 5, the case 100 includes a housing 102 having an outer wall 104 defining the interior 108 of the case 100. A first wall 110 is positioned in the interior 108 of the case 100 and defines an aperture 112. The first wall 110 is connected to the outer wall 104 and is positioned transverse to the air pathway 109 as generally shown. A second wall 114 is positioned in the interior 108 of the case 100 downstream of the first wall 110 and defines an aperture (not shown). The second wall 114 is connected to the outer wall 104 and is positioned transverse to the air pathway 109 in a similar manner as the first wall 110. The first wall 110 and the second wall 114 define an interior cavity 116 for receipt of a dryer cartridge 118 (discussed further below). At least one fan 119 (two shown) described below forces the humid air 16 along the air pathway 109 through the aperture 112 in the first wall 110, through the dryer cartridge 118, and the dehumidified air 14 received from the dryer cartridge 118 through the aperture in the second wall 114.

In the FIGS. 4 and 5 example, the case 100 includes a lid 107 configured to move relative to the housing 102 to close the housing 102 defining the interior 108 of the case 100. In one example, the lid 107 (or the housing 102) includes a seal (not shown) and is configured to close and sealingly engage the housing 102 creating an air tight, or substantially air tight, interior 108 of the case 100. In one example, the case 100 is a portable, hand held case which can be easily transferred to and positioned adjacent to or in proximity of the IC engine 12. In one example, the case 100, and/or the outer wall 104 and lid 107 are made from a lightweight, high impact resistant and weather resistant polymer or composite material. Other materials and configurations for the case 100 may be used to suit the particular application and environment as known by persons skilled in the art.

In the example, the first wall 110 and the second wall 114 define the interior cavity 116 for receipt of the dryer cartridge 118. The dryer cartridge 118 is positioned in the interior 108 of the case 100, in the interior cavity 116, in communication with the air pathway 109 and is configured to remove the humidity from the humid air 16 in the air pathway 109 as further described below.

Referring to the FIGS. 4 and 5 example, the dehydrator 50 includes at least one fan 119 having a fan speed in communication with the air pathway 109 and the air inlet 105 and the air outlet 106. The at least one fan 119 draws the humid air 16 from the interior of the IC engine 12 into the dehydrator 50, forces the humid air 16 along the air pathway 109 through the aperture 112 in the first wall 110, through the dryer cartridge 118, and forces the dehumidified air 14 through the aperture in the second wall 114. In one example, the at least one fan 119 includes a single fan positioned either upstream of the dryer cartridge 118 (e.g., upstream of the first wall 110) or downstream of the dryer cartridge 118 (e.g., downstream of the second wall 114). It is understood that in a single fan configuration, the single fan can be alternately positioned in the interior 108 of the case 100, be positioned outside the case 100, or may be connected to and/or in communication with the air inlet tube 54 or the air outlet tube 58 as known by persons skilled in the art.

In the FIGS. 4 and 5 example, the at least one fan 119 includes a first fan 120 and a second fan 124. The first fan 120 is positioned in the interior 108 of the case 100 upstream of the first wall 110. The first fan 120 is in communication with the air inlet tube 54 and is configured to force the humid air 16 received from the interior of the IC engine through the aperture 112 in the first wall 110 and through the dryer cartridge 118. The second fan 124 is positioned in the interior 108 of the case 100 downstream of the second wall 114. The second fan 124 is in communication with the air outlet tube 58 and is configured to draw the humid air 16 through the dryer cartridge 118, through the aperture in the second wall 114 and through the second fan 124. The second fan 124 is configured to force the dehumidified air 14 through the air outlet 106 and through the air outlet tube 58.

In one example, the first fan 120 and the second fan 124 are electrically powered fans having a fan speed. In one example, the first fan 120 and the second fan 124 include a variable speed and variable rate of air flow. In one example as best seen in FIG. 4, the first fan 120 is configured in the form of a hemispherical or rounded dome shape as generally shown which facilitates efficiently drawing in the humid air 16 from the IC engine 12 through the air inlet tube 54 and providing the humid air 16 to the dryer cartridge 118. In one example, the first fan 120 and the second fan 124 are centrifugal fans.

In one example, the first fan 120 and the second fan 124 have a fan or impeller blade. In one example, the fan speed (e.g., rotation of the impeller blade) is between about 500-7200 revolutions per minute (RPM) and a rate of air flow between about 1-47 cubic feet per minute (CFM). It is understood that different fan speeds and air flow rates, both higher and lower, may be used to suit the particular application and performance requirements as known by persons skilled in the art. In one example, when the at least one fan 119 is stopped or not operating, the fan speed is zero (e.g., zero RPM). As further described above and below, the rate of speed of the first fan 120 and the second fan 124 may be increased or decreased depending on the measurement of humidity and temperature by the sensors described below.

It is understood that the first fan 120 and the second fan 124 can take alternate positions relative to the case 100 as disclosed for a single fan configuration above, and be alternately configured (e.g., alternate numbers of fans, fan speeds, flow rates, fan construction, and operation) as known by persons skilled in the art. In one example, the first fan 120 and the second fan can have the same fan speed and/or same air flow and may be operated in coordinated manner (e.g., energized, deenergized, increased or decreased fan speed, together), or may have different fan speeds and/or airflow, and/or be operated independently from one another by the controller 130 described further below. In one example, one of the first fan 120 or the second fan 124 may be energized and used without the other, or may both be energized when conditions such as a high level of humidity in the humid air 16 are detected.

In one example of operation of the system 10, the second fan 124 is operated at a higher fan speed (i.e., at a higher fan speed and/or higher revolutions per minute (RPM), and/or at a higher flow rate (i.e., cubic feet per minute (CFM)), than the first fan 120. In one example, wherein the first fan 120 has the same or about the same air flow volume, the fan speed of the second fan 124 is 1.8x higher than the fan speed of the first fan 120. (e.g., if the fan speed of the first fan 120 is set or configured to be at 1000 RPM, then the fan speed for the second fan 124 is set or configured to be at 1800 RPM). This ratio may equally apply to a flow rate (CFM).

It has been determined through testing that a higher fan speed (or alternately a higher air flow rate) of the second fan 124 compared to the first fan 120 is advantageous in better circulation of the dehumidified air 14 in the interior of the IC engine (e.g., an aircraft engine) and/or for the return of humid air 16 from the IC engine to the dehydrator 50. Stated another way, a higher fan speed or flow rate of the second fan 124 ensures a positive pressure (i.e., a higher air pressure than an atmospheric air pressure in an environment surrounding the exterior of the IC engine 12 or the dehydrator 50) inside the interior of the IC engine 12 (i.e., there is more air (i.e., dehumidified air 14) flowing into the IC engine 12 than humid air 16 being drawn from the interior of the IC engine 12) maintaining positive crankcase pressure (PCP). It is understood that the higher fan speed (or higher air flow rate) of the second fan 124 relative to the fan speed of the first fan 120 may vary, both higher or lower in value, and/or higher or lower in ratio (e.g., higher or lower than the example 1.8x), depending on the configuration of the system 10, the configuration of the IC engine 12, and other factors as known by persons skilled in the art.

In an alternate example disclosed below, one or more sensors, for example an air pressure sensor, a humidity sensor, an air flow sensor, and/or a temperature sensor, may be used on the elongate tube of the oil filler fitting 70 to measure and monitor one or more of the air pressure, humidity, and/or temperature, and/or other metrics described herein, in the interior of the IC engine 12. In one example wherein the sensor is an air pressure sensor connected to the elongate down tube of the oil filler filling, the air pressure sensor is used to measure air pressure in the interior of the IC engine 12 to ensure the at least one fan (e.g., the first fan 120 and the second fan 124) is at a fan speed to maintain a positive air pressure in the interior of the IC engine 12 (i.e., PCP).

In the FIGS. 4 and 5 example, the dehumidification system 10 includes a first sensor 122 positioned upstream of the dryer cartridge 118 and configured to measure metrics of the sealed dehumidification system 10.

In one example, the metrics include at least one of humidity (e.g., the humidity of the humid air 16 and/or the humidity of the dehumidified air 14), temperature, airflow (e.g., cubic feet per minute (CFM)), air pressure (e.g., pounds per square inch (PSI)), fan speed of the at least one fan 119 (e.g., revolutions per minute (RPM) of the first fan 120 and/or the second fan 124), and/or energy consumption of the at least one fan 119 (e.g., the electrical load of the at least one fan 119 that the fan is requiring or drawing during operation, for example in Amperes (A) or Watts (W)). In the example, the system 10 includes a second sensor 126 positioned downstream of the dryer cartridge 118 and configured to measure the metrics of the sealed dehumidification system 10 described above for the first sensor 122.

In the FIGS. 4 and 5 example, the system 10 includes a controller 130 in communication with the first sensor 122, the second sensor 126, and the at least one fan 119. The controller 130 is configured to monitor signals respectively received from the first sensor 122 and the second sensor 126, compare the signals respectively received to predetermined values, and adjust operation of the sealed dehumidification system 10 based on the signals respectively received and compared to the predetermined values.

In the FIGS. 4 and 5 example, the first sensor 122 and the second sensor 126 are configured to monitor the predetermined or assigned metric for the respective sensor. The sensors are configured or programmed to measure the metric and send an electronic signal to the controller 130 at predetermined intervals, for example an interval of time (e.g., seconds, minutes, hours, days, and/or weeks). The signals sent by the sensors to the controller 130 may be through hard line (e.g., wires) or sent wirelessly (e.g., BLUETOOTH or other known wireless communication protocols).

The controller 130, as further described below, may be a computer or other programmable controller, and include hardware and software stored in a storage medium, and through an operating system and/or software, converts the signals to data and mathematically compares the data from the signals received to predetermined values stored in the storage medium. In one example, the predetermined values may include values or numbers wherein predetermined instructions are stored for the system, for example for the at least one fan 119, to execute a predetermined action (e.g., to energize, deenergize, increase the fan speed, or decrease the fan speed, of the at least one fan 119). It is understood that the sensors, the controller 130, the metrics, and/or the predetermined values may take other forms, configurations, values, functions, and/or operation to suit the particular application and performance requirements of the system 10 as known by persons skilled in the art.

In one example shown in FIGS. 4 and 5, the first sensor 12 is a first humidity sensor 122A positioned upstream of the dryer cartridge 118 and is configured to measure the humidity of the humid air 16 received from the interior of the IC engine 12. In one example as best seen in FIG. 4, the first humidity sensor 122A is positioned upstream of the first fan 120 as generally shown. In one example, the first humidity sensor 122A may be connected to or positioned in the air inlet tube 54. In an alternate example, the first humidity sensor 122A may be positioned on, or integrated into a sensor on the first fan 120, for example mounted to a fan housing and in communication with the flow of humid air 16 circulating through the first fan 120. In the example, the controller 130 is configured to energize, deenergize, increase the fan speed, or decrease the fan speed (e.g., of the first fan 120) based on the humidity as measured by the first humidity sensor 122A.

In one example shown in FIGS. 4 and 5, the second sensor 126 is a second humidity sensor 126A positioned downstream of the dryer cartridge 118 and is configured to measure a humidity of the dehumidified air 14 received from the dryer cartridge 118. In the example, the controller is configured to energize, deenergize, increase the fans speed (e.g., of the second fan 124) based on the humidity as measured by the second humidity sensor 126A in a similar manner as described above for the first humidity sensor 122A. In one example, the second humidity sensor is connected to or positioned in the air outlet tube 58. In an alternate example, the second humidity sensor may be positioned on the second fan 124 or integrated with the second sensor 126 positioned on the fan as described above for the first humidity sensor 122A. It is understood that the first humidity sensor 122A and the second humidity sensor 126A may be positioned in alternate locations of the system 10 upstream or downstream of the dryer cartridge 118, respectively, and/or may be combined or integrated with other sensors to measure the metrics as described in the examples herein.

In one example, the controller 130 is configured to compare the humidity measured by the first humidity sensor 122A to the humidity measured by the second humidity sensor 126A and calculate a differential humidity 139 to monitor the effectiveness or condition of a dryer media 176 (discussed further below) positioned in the dehydrator 50 in removing humidity from the humid air 16 received from the interior of the IC engine 12. In the example, the controller 130 is configured to deenergize (i.e., turn off and reduce the fan speed to zero) when the differential humidity falls below a predetermined value or level indicative of a condition that the dryer media is saturated (i.e., no longer capable of efficiently or effectively removing additional humidity from the humid air 16). In one example, the system 10 includes a display panel 134 in communication with the controller 130 configured to display the differential humidity as calculated by the controller 130.

In one example, the humidity measured by the first humidity sensor 122A and the second humidity sensor 126A is relative humidity of the humid air 16 and the dehumidified air 14, respectively. In an alternate example, the first sensor 122 and the second sensor measure absolute humidity of the humid air 16. For purposes of convenience, humidity as used herein is relative humidity unless otherwise noted. In another example, both relative humidity and absolute humidity may be measured and/or calculated. In one example, the system 10 may include a separate sensor, for example on the exterior of the housing 102, to measure the humidity of the environment surrounding the dehydrator 50.

In one example, at least one of the first sensor 122 and/or the second sensor 126 are configured to measure the fan speed of the at least one fan 119 (e.g., the first fan 120 and the second fan 124). In one example, the controller 130 is configured to energize or deenergize the at least one fan 119 based on the humidity measured by at least one of the first humidity sensor 122A or the second humidity sensor 126A. In one example, the controller 130 is configured to increase the fan speed or decrease the fan speed as measured of the at least one fan 119 based on the humidity measured by at least one of the first humidity sensor 122A or the second humidity sensor 126A.

In one example, at least one of the first sensor 122 or the second sensor 126 are configured to measure a temperature of the humid air 16 received from the interior of the IC engine 12 or a temperature of the dehumidified air 14 received from the dryer cartridge 118, respectively. In the example, the controller 130 is configured to energize, deenergize, increase the fan speed, or decrease the fan speed, of the at least on fan 119 based on the temperature as measured by at least one of the first sensor 122 or the second sensor 126. In one example, the system 10 includes a sensor to measure a temperature of the ambient air of the environment surrounding the dehydrator 50.

In one example, the first sensor 122 and/or the second sensor are configured to continuously monitor the metric (e.g., humidity, fan speed, and/or temperature) and continuously send signals to the controller 130. As described above, the sensors and or the controller 130 may be configured such that the sensors measure and send the signals of the respective measurement to the controller 130 at predetermined intervals (e.g., time interval between measurements). In one example wherein the IC engine 12 is an aircraft engine, the controller 130 is configured to energize (i.e., turn on) an inactive or not operating fan (i.e., fan speed is zero) (e.g., the first fan 120 and/or the second fan 124) when the first humidity sensor 122A measures or detects the humidity of the humid air 16 above a predetermined value or level, for example above 20% relative humidity. In an alternate example, the predetermined value that the that the first humidity sensor 122A is activated or turned on is 18% humidity. In an alternate or additive example, the predetermined value for a humidity measurement for the second humidity sensor 126A when the fan(s) are deactivated is 10% humidity. It is understood that the predetermined value (e.g., humidity measurement) for energizing or deenergizing the at least one fan 119 (e.g., the first humidity sensor 122A and/or the second humidity sensor 126A) may vary, higher or lower, depending the type of IC engine 12, the environment the IC engine is in, a user’s preference, or other factors known by persons skilled in the art.

In one example, the controller 130 may increase the fan speed of the at least one fan 119 (e.g., the first fan 120 and/or the second fan 124) when the humidity of the humid air 16 is above a predetermined value or level (e.g., high humidity above 35%) to increase the airflow through the dryer cartridge 118 and accelerate the drying or humidity removal from the humid air 16. In an alternate example as discussed above and further below, if the differential humidity 139 is below a predetermined value, for example 15% (indicating a reduced effectiveness of the dryer cartridge 118 to remove humidity due to dryer media saturation), the controller 130 may increase the fan speed to increase the airflow to accelerate the removal of humidity from the humid air 16 and increase the differential humidity 139 such that the dehumidified air 14 is within an acceptable predetermined range or value for the differential humidity 139 to transfer to the IC engine 12. It is understood these predetermined values may vary, both higher and lower, depending on factors for the predetermined values noted above and disclosed herein.

In one example, the controller 130 may decrease the fan speed of the at least one fan 119 (e.g., the first fan 120 and/or the second fan 124) when the humidity of the humid air 16 as measured is quickly or steadily lowering (e.g., from a high level of humidity toward a target or low level of humidity) so as to, for example, conserve energy if the system 10 is operating on battery power.

In one example, the controller 130 may deenergize (i.e., turn off to a zero fan speed) the at least one fan 119 (e.g., the first fan 120 and/or the second fan 124) when the humidity of the humid air 16 as measured falls below a predetermined or target value (e.g., 10 percent). In an alternate example, if the differential humidity 139 as measured and calculated falls below a predetermined value (e.g., 15 percent or 10 percent) and does not increase for a predetermined period of time indicative that that dryer cartridge 118 or the dryer media is saturated and no longer effective to remove humidity from the humid air 16. The shutting off of the at least one fan 119 and/or the shutting down of the system 10 is advantageous to, for example, preserve battery power and/or prevent unnecessary running of the at least one fan 119 and other system 10 components. In an alternate example, if the metric, or one of the metrics, as measured by the sensors is the energy consumption by the at least one fan 119 as described above, and the measurement is above a predetermined value for a predetermined period of time, which is indicative of a malfunctioning fan and/or overworking of the fan, the controller 130 may deenergize the at least one fan 119 to prevent overheating or damage to the at least one fan 119 and/or other components of the system 10.

In one example, the first sensor 122 (upstream of the dryer cartridge 118) or the second sensor 126 (downstream of the dryer cartridge 118) includes an air pressure sensor 122C (numbered for convenience of description only) configured to measure an air pressure in the interior of the IC engine 12. In one example, the air pressure sensor is connected (e.g., embedded, molded into, or otherwise connected to) the elongate down tube 196 (see FIGS. 1, 8 and 9 discussed further below) of the oil filler fitting 70. In one example, the air pressure sensor 122C is positioned about six (6) inches above the second end 202 of the elongate down tube 196. It is understood that the air pressure sensor 122C can take other positions along the elongate down tube 196. In one example as described for the other of the first sensor 122 and the second sensor 126, the air pressure sensor 122C sends signals indicative of the air pressure inside the IC engine 12 to the controller 130 which may compare the measured air pressure to predetermined values stored in the controller 130 and/or an atmospheric pressure as described below.

In one example, the measured air pressure by the air pressure sensor 122C may be used by the controller to adjust the fan speed of the at least one fan 119 to control or maintain a predetermined or desirable air pressure in the interior of the IC engine 12 to ensure a positive pressure (i.e., PCP) in the interior of the IC engine 12 to promote circulation and proper return air flow of humid air 16 back to the dehydrator 50. In one example where the first fan 120 and the second fan 124 are used as described in the examples above and herein, the controller 130 is configured to automatically adjust the fan speed of the first fan 120 and/or the second fan 124 to maintain a predetermined air pressure or within a range of air pressures (e.g., positive pressure, PCP) in the interior of the IC engine 12. In one example, a separate air pressure sensor (not shown) configured to measure the air pressure (e.g., the atmospheric air pressure) in an environment surrounding the exterior of the IC engine 12 or the dehydrator 50 is used and in communication with the controller 130.

In one example, the controller 130 is configured to increase the fan speed of the second fan 124 to increase the volume of air flow of dehumidified air 14 into the interior of the IC engine 12 (e.g., through the oil filler port 22 and the exhaust pipe 42) such that the air pressure as measured by the air pressure sensor 122C is at or above the predetermined air pressure value for the interior of the IC engine 12 to maintain a positive air pressure in the interior of the IC engine 12 (i.e., PCP). Alternately, or in addition to, increasing the fan speed of second fan 124, the fan speed of the first fan 120 could be decreased. In an alternate example, the air pressure sensor 122C is a separate sensor from the above described and illustrated first sensor 122 and the second sensor 126, for example a separate air pressure sensor connected to the case 100 of the dehydrator 50. In the examples described, through use of the air pressure sensor 122C and the controller 130 as described, the controller 130 is configured to automatically adjust the fan speed of the at least one fan 119 ensuring proper, or optimal, air pressure (e.g., positive air pressure, PCP) and/or circulation of air through the interior of the IC engine 12 and the removal of humidity from the IC engine 12.

As noted above, the one or more sensors connected to the elongate down tube 196 of the oil filler fitting 70 may be a different sensor (e.g., humidity, temperature and/or air flow) than an air pressure sensor, or may be additional sensors included with, or in combination with, the air pressure sensor 122C in the described example. It is understood that alternate types and forms of sensors, and the configuration and operation of the air pressure sensor 122C and the controller 130 to adjust the operation of the system 10, may vary to suit the particular application and performance requirements of the system 10 as known by persons skilled in the art.

In one example, the controller 130 is configured to receive and compare the air pressure sensor measurements of the air pressure sensor 122C to the atmospheric air pressure as measured and calculate a difference, or a differential air pressure, and compare that to a predetermined value, or range of predetermined values. In one example, if the differential air pressure is below the predetermined value (indicative of low air pressure or negative air pressure in the interior of the IC engine 12) the controller is configured to adjust the fan speed of the at least one fan 119 to increase the air pressure in the interior of the IC engine 12. In one example where the first fan 120 and the second fan 124 are used, the controller is configured to increase the fan speed, and thus the volume flow of air, of the second fan 124 until the air pressure as measured by the air pressure sensor 122C is at or above the predetermined value as stored in the controller 130. It is understood that the receipt of measurements from the one or more sensors on the elongate down tube 196 and the controller 130 to adjust the operation of the system 10, may be used in a similar manner as described for the air pressure sensor 122C. It is understood that other sensors, components, configurations, measurements, calculations and operations may be used to measure and monitor the air pressure, or other metrics described above, in the interior of the IC engine 12, and the controller configured to adjust the operation of the system 12, may be used as known by persons skilled in the art.

In one example of operation of the system 10 and the controller 130 adjustment of the operation of the system 10 based on signals received from the sensors, the controller 130 is preprogrammed and configured to monitor, calculate, and execute the adjustments to the system 10 (e.g., energize, deenergize, increase or decrease the fans speed of the at least one fan 119) based on individual or combinations of the measurements from at least one of the first sensor 122, the second sensor 126, additional sensors (e.g., measuring the temperature and/or humidity of the ambient air in the environment surrounding the dehydrator), and other variables (e.g., time) such that the humidity of the interior of the IC engine 12 is reduced or maintained at or below a predetermined value or level (e.g., 20 percent).

In one example, preprogrammed instructions or algorithms stored in the controller 130 are used to monitor the humidity and/or other metrics identified above and make adjustments to the system 10 (e.g., the at least one fan 119) such that the interior of the IC engine 12 is continuously preserved or maintained at predetermined values as long as the system 10 is connected to the IC engine 12 at rest, and has a power source (e.g., plugged in electrical power or a battery described below). In an alternate example, the programmed instructions and/or algorithms may be stored and executed by a separate device, for example a laptop, a personal digital assistant (PDA), tablet (e.g., iPAD), or a smart phone with suitable software or applications, in communication with the controller 130. In an alternate example described below, the controller 130 may have one or more preprogramed modes of operation based on, for example, time intervals, such that the system 10 is activated to circulate the dehumidified air 14 through the interior of the IC engine 12 for preprogrammed times or between time intervals.

It is understood that the system 10 may include more than one first sensor 122 and more than one second sensor 126. In one example, the second sensor 126 is not included in the system 10. It is understood that the first sensor 122 and/or the second sensor 126 may individually include more than one, or a plurality of sensors, that are integrated into a single sensor unit. It is understood that the metrics measured may include two or more metrics, a combination of the metrics, or all of the above mentioned example metrics, or alternate metrics, to suit the particular application and performance requirements of the system 10. It is understood that the controller 130 adjustment to the operation of the system 10 based on the measurements by the sensors and the signals sent thereby, may vary depending on the sensors and the metrics measured. It is understood that adjustments to the operation of the system 10 by the controller 130 may include adjustments other than to energize, deenergize, increase the fan speed, or decrease the fan speed to suit the particular application and performance requirements of the system 10 as known by persons skilled in the art.

As best seen in the example in FIG. 4 and as described above, the first sensor 122 and the second sensor 126 may be positioned in the interior 108 of the housing 102. It is understood that the first sensor 122 and the second sensor 126 may be positioned in alternate locations in the interior 108 of the case 100 remaining in communication with the humid air 16 and the dehumidified air 14, respectively. In one example (not shown), the first sensor 122 and/or the second sensor may be positioned outside of the interior 108 of the case 100, for example on the outside exterior surfaces of the outer wall 104 or connected to the air inlet tube 54 or the air outlet tube 58, respectively..

As best seen in the FIGS. 4, 5 and 7 example, the controller 130 is positioned in the interior 108 of the case 100 in communication with the first sensor 122, the second sensor 126, and the at least one fan 119. In one example, on receipt of the signals from the first sensor 122 and/or the second sensor 126 that the measured humidity in the humid air 16 and/or the dehumidified air 14 is higher than a predetermined level as described above, the controller 130 may be preprogrammed and configured to energize the at least one fan 119 to and begin continuously circulating dehumidified air 14 through the interior of the IC engine 12. Humid air 16 is received from the interior of the IC engine 12 is passed through the dryer cartridge 118 and back through the interior of the IC engine 12 until, for example the measured humidity in the humid air 16 is below a predetermined level. In one example, the controller 130 may alternately keep the at least one fan 119 energized (i.e., running) for a predetermined period of time as described further below.

In one example of operation, the controller 130 is configured to energize the at least one fan 119 to draw the humid air 16 from the IC engine 12 and force the humid air 16 through the dryer cartridge 118 when the humidity of the humid air 16 measured by the first sensor 122 is above the predetermined level. In one example wherein the IC engine 12 is an aircraft engine, the predetermined level of humidity wherein the controller 130 starts or energizes the at least one fan 119, or determines that a run cycle (described further below) or an activation cycle for the system 10 is needed to remove humidity from the IC engine 12, is 20% relative humidity. In alternate examples, 50%, 55%, 60%, 35%, 30%, 25%, 20%, 18%, 15%, 10% or 5%, and any increments therebetween, humidity may be the predetermined humidity level wherein the controller 130 is preprogrammed and configured to energize the at least one fan 119 and circulate the dehumidified air 14 inside and through the interior of the IC engine 12 as described. Alternate predetermined levels of humidity, higher or lower, in incremental values, wherein the at least one fan 119 is energized or started, or it is determined or calculated by the controller 130 to remain running, or to initiate a run cycle mode described further below, may be used depending on the application (e.g., the type of IC engine), environment and/or performance requirements.

In one example, the controller 130 includes a micro or small computer including a central processing unit (CPU), a memory storage device (e.g., a hard disk, solid state drive or other memory storage device known by persons skilled in the art), input devices for entering commands or instructions into the controller 130, output devices for receiving output signals or data from the controller, a timer or clock configured for tracking time of an actuation or operation of components and/or an interval time period between activation or run cycles, an operating system for the CPU, programmable software for operation of dehydrator 50 including actuation and operation of components of the dehydrator 50, and a power supply, for example a rechargeable battery or a power cord for connecting to an electrical outlet of a building, an air plane hangar, or other facility in which the IC engine 12 is stored. Additional or alternate hardware and/or software, including that described above, may be used in controller 130 to suit the particular application, features and performance requirements as known by persons skilled in the art.

As shown in the FIG. 5 example, the case 100 may include a communication port 142 accessible from an exterior of the case 100 in communication with the controller 130, wherein electronic communication or data cables may be connected to the communication port 142 to send and/or receive signals, data or other communications to and from the controller 130. In an alternate example (not shown) the communication port 142 may be positioned in the interior 108 of the case 100. In one example, a personal computer, tablet, smart mobile phone, or other device (not shown) may be connected to the communication port 142 to communicate with the controller 130 to, for example, run diagnostics on the controller 130 or dehydrator 50, update the software of the controller 130, troubleshoot and/or correct problems with the controller 130, or other operations known by those skilled in the art. Alternately, the controller 130 may be configured to send and/or receive signals, data or other communications wirelessly through wireless hardware, software and wireless communication protocols noted above.

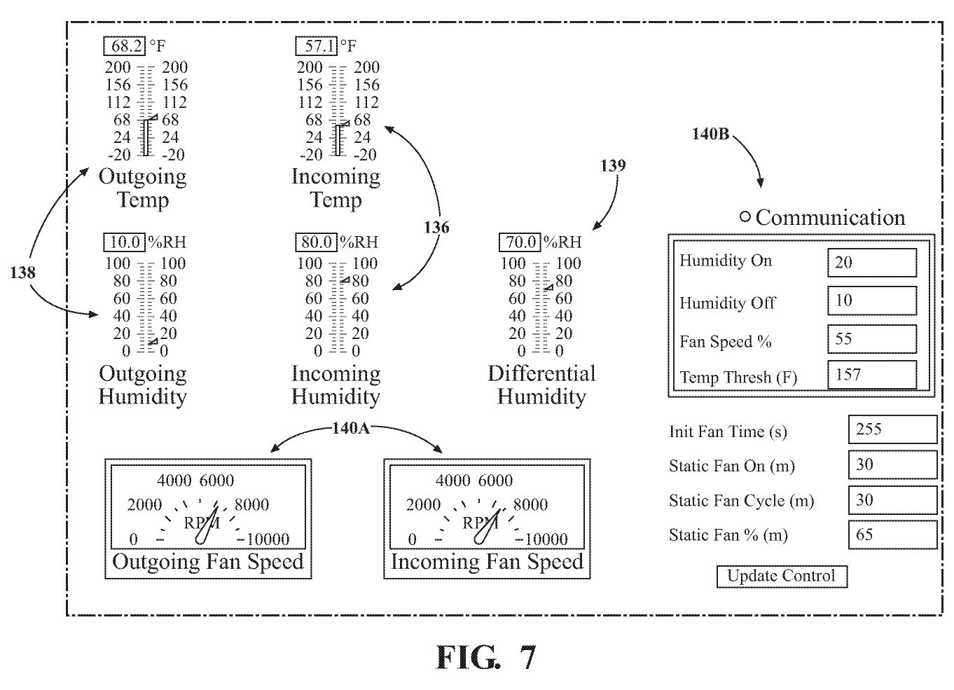

In the example as best seen in FIGS. 4, 5 and 7, the dehydrator 50 includes a display panel 134 connected to the case 100 and positioned in the interior 108 of the case 100. The display panel 134 is in communication with the controller 130, and through a graphic user interface (GUI), is configured to display, for example, one or more of the metrics noted above (e.g., humidity and/or temperature) as measured by the sensors (e.g., the first sensor 122 and/or the second sensor 126). As best seen in the FIG. 7 example, the temperature and/or the humidity measurements from the first sensor 122 (e.g., incoming (i.e., upstream of the dryer cartridge 118)) temperature and incoming humidity) and the second sensor 126 (e.g., outgoing (i.e., downstream of the dryer cartridge 118) temperature and/or humidity), and the fan speed (e.g., incoming fan speed (i.e., the first fan 120) and outgoing fan speed (i.e., the second fan 124)). In one example, the first fan 120, the second fan 124, the first sensor 122, the second sensor 126, and the display panel 134 are in electronic communication with the controller 130 through wires or cables. In an alternate example, the sensors, fans and displays may be in communication with the controller 130 through a wireless communication protocol, for example BLUETOOTH or other wireless communication protocols known by persons skilled in the art.

Referring to the FIGS. 5 and 7 examples, the display panel 134 may be positioned in the interior 108 of the case, for example on an inside of the lid 107 where it is visible when the lid 107 is open relative to the housing 102. In an alternate example (not shown), the display panel 134 may be positioned in an alternate position in the interior 108 of the case 100 when the lid 107 is open, or on the exterior of case 100 to be visible when the lid 107 is closed and engaged with the housing 102. Alternate positions of the display panel 134 in the interior 108, on the exterior of the case 100, or remotely from the case 100 (e.g., a laptop computer, tablet or smart mobile phone in the vicinity or remote from the dehydrator 50), may be used.

The display panel 134 may take any form of conventional computer monitor, tablet (e.g., iPAD) or smart mobile phone technologies, for example liquid crystal display (LCD) panels that provide the GUI for a user. Other forms of display panels, for example LED, may be used as known by persons skilled in the art. The display panel 134 may be a touch screen input device, or another accessory or peripheral device (not shown) may be used to provide inputs or commands to the controller 130. It is understood that the display panel 134 may not be included in or on the dehydrator 50 or system 10.

In an alternate example, a peripheral or remote device, for example a tablet (e.g., iPAD), smart mobile phone or personal computer, may be selectively connected by a user to the communication port 142 (e.g., through a cable and USB connector), or wirelessly (e.g., BLUETOOTH, cellular or other communications protocols) and, along with coordinating software or application stored on the remote device, serve as the display panel 134 in communication with the controller 130. When the example peripheral device is connected and communicates with the controller 130, the peripheral device may serve as an input device to send commands to the controller 130 and/or serve as an output device, for example the display panel of the peripheral device serves as the display panel 134 as described herein.

Referring to FIG. 7, an example of the display panel 134 including the GUI is shown. In the example, the display panel 134 is connected to the case 100, for example to the lid 107, as described above. In coordination and receipt of signals and/or data from the controller 130 in communication with the first sensor 122, the second sensor 126, the first fan 120, and the second fan 124, the system 10 may display on the display panel 134, through the GUI, one or more of the metrics noted above. In one example, the metrics include inlet metrics as measured by the first sensor 122 (or first sensors). In one example of the one or more inlet metrics, incoming or an inlet temperature and/or an incoming or an inlet humidity (e.g., relative humidity) received from the first sensor 122 upstream of the dryer cartridge 118 may be displayed. This example provides and displays the measured data of the temperature and the humidity of the humid air 16 received (i.e., forcibly drawn) from the interior of the IC engine 12 by the at least one fan 119 (e.g., first fan 120 or in combination with the second fan 124 as best seen in FIG. 4 and described above).

The display panel 134 may also display one or more outlet metrics 138 as measured by the second sensor 126 (or second sensors. In one example of the one or more outlet metrics 138, an outgoing or an outlet temperature, and an outgoing or an outlet humidity (e.g., relative humidity) received from the second sensor 126 downstream of the dryer cartridge 118 may be displayed. This example provides and displays the measured data of the temperature and the humidity of the dehumidified air 14 received from (i.e., forcibly passed through) the dryer cartridge 118 by the at least one fan 119 (e.g., the second fan 124 or in combination with the first fan 120).

In one example, another metric, for example the differential humidity 139, the difference between the inlet humidity (e.g., from the first humidity sensor 122A) and the outlet humidity (e.g., from the second humidity sensor 126A) as described above may be displayed on the display panel 134 as generally shown. The differential humidity 139, for example, provides a visual indication whether the dryer cartridge 118 is effectively removing or reducing the humidity in the humid air 16 received from the interior of the IC engine 12 after having passed through the dryer cartridge 118. In one example, if the differential humidity 139 as calculated is below a predetermined level (e.g., 30 percent) for a predetermined period of time (e.g., 45 minutes), the controller 130 may deenergize (i.e., turn off) the at least one fan 119 (e.g., the first fan 120 and the second fan 124). In an alternate example, if the differential humidity 139 as calculated is at a predetermined level (e.g., 25 percent) the controller 130 may output a signal or alert to the display panel 134 that, for example, the dryer cartridge 118 is no longer efficiently removing humidity and needs attention, reactivation or replacement. It is understood that the differential humidity 139 values and predetermined time values to alert a user to check or service the dryer cartridge 118 (or the dryer media discussed below), or for the system 10 to deenergize the at least one fan 119, may vary, both higher and lower, than the example percentages provided as known by persons skilled in the art.

In one example of the controller 130 and/or the display panel 134, the system 10 allows the user to adjust or set different values or target values for relative humidity, temperature, differential humidity 139, fan speed, and/or the other metrics identified above, through the display panel 134 or another input device (e.g., a laptop, tablet, or smart mobile phone) in communication with the controller 130. This allows the user to customize, deviate, or temporarily override the preprogrammed settings or modes of operation of the controller 130 to, for example, adjust operation based on environmental conditions. In alternate examples of operation or modes described below, these values may be preprogrammed or default values stored in the controller 130.

In another example, the controller 130 through the display panel 134 may display other of the metrics than those described above for FIG. 7, for example the fan speed of the at least one fan 119 (e.g., first fan 120 and second fan 124) as shown in FIG. 7 (identified as 140A for convenience of illustration only). In one example shown in FIG. 7, the fan speed may be calculated by the controller 130 and displayed as a percentage of the operating capacity or speed of the at least one fan 119, or in the case of the use of the first fan 120 and the second fan 124, a combined capacity (e.g., between 0% - 100%, shown as 55% in FIG. 7). In one example of the dehydrator 50 and the controller 130, the controller 130 may have one or more predetermined or default fan speeds to provide sufficient flow of forced air through the IC engine 12 and the dehydrator 50 to achieve a sufficient reduction of humidity from the humid air 16 received from the interior of the IC engine 12. In another example, the dehydrator 50, the controller 130, and/or the display panel 134 may provide for a user to manually decrease or increase the fan speed to respectively reduce or accelerate the removal of humidity from the humid air 16. In an alternate example, the display of fan speeds is not used.

In one example, the display panel 134 and/or the GUI may include a visual display of a timer or time metrics (see reference 140B in FIG. 7). In one example, the controller 130 may include a predetermined run time or period (e.g., Initial Fan Time and Static Fan Cycle shown in FIG. 7) wherein the at least one fan 119 is energized (i.e., on or running) providing or circulating forced air along the air pathway 109 through the dehydrator 50 and the IC engine 12. In alternate example of time metrics, a running clock or timer may be shown providing a visual indication of the time that the at least one fan 119 has been running (i.e., how long the dehydrator 50 has been running in a start-up mode or run cycle mode (discussed further below) and/or the remaining time that the dehydrator 50 has left until the controller 130 deenergizes or turns off the at least one fan 119).

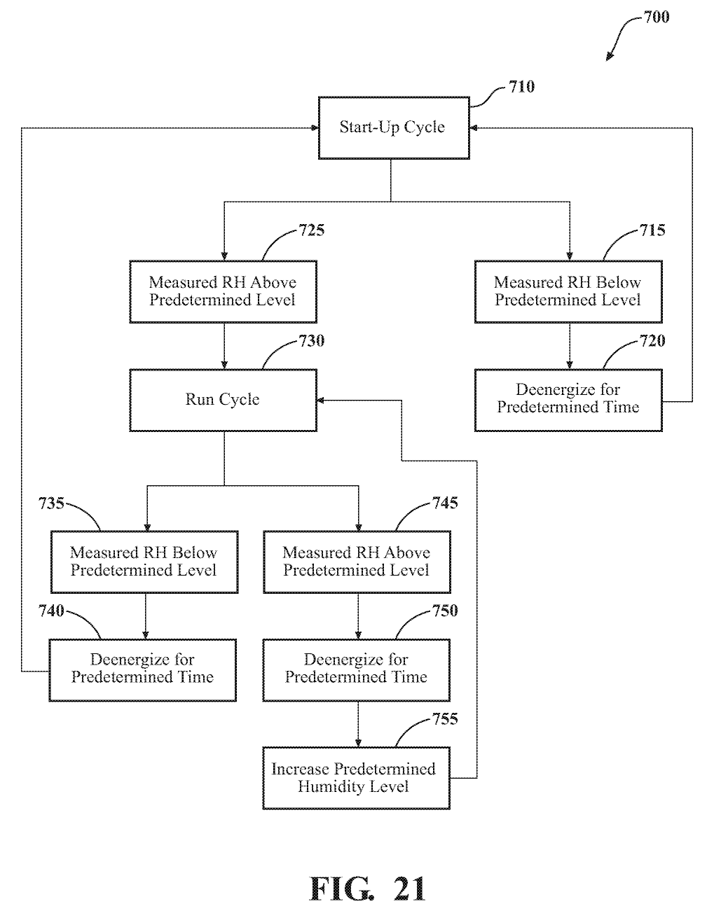

Referring to FIG. 21 an example of a method of operation 700 of the system 10 and the dehydrator 50 is shown. In one example, the controller 130 may have one or more preprogrammed modes, operation or cycles, that can be stored in the memory storage device and set as a default or alternately manually chosen by a user for operation of the system 10. In one example, the controller 130 includes a start-up mode or a start-up cycle 710. In the example of the start-up cycle 710, the controller 130 energizes the at least one fan 119 for the predetermined run time (e.g., Initial Fan Time in FIG. 7), for example 255 seconds. In the example of the start-up cycle 710, humid air 16 is drawn from the interior of the IC engine 12 by the at least one fan 119 for 255 seconds, is forced through the dehydrator 50 in communication with the first sensor 122 and the second sensor 126, and back to the interior of the IC engine 12 to measure one or more of the metrics described above (e.g., humidity of the humid air 16 received from the IC engine 12) as described above.

In one example of a method of operation 700 as best seen in FIG. 21, the system 10 is configured to run the start-up cycle 710 after a predetermined time as measured by the controller 130. In one example, the start-up cycle 710 is initiated every 30 minutes following when the at least one fan 119 was last deenergized or stopped (e.g., Static Fan Cycle, for example 30 minutes (m) in FIG. 7). In an alternate example, the predetermined time to initiate the start-up cycle may be alternate values, for example, every 3 – 4 hours, once per day, once per week, once per month, depending on the use of the IC engine 12 and/or the environmental conditions (e.g., high temperature and/or high environmental humidity). It is understood that alternate predetermined time values between start-up cycles (e.g., 30m) and the duration of run time for the start-up cycle (e.g., 255 seconds), both longer and shorter, and incremental values therebetween, may be used. In one example, a user may manually initiate the start-up cycle 710 and initial fan time duration.

In one example, during the start-up cycle 710, the fan speed may be set at a higher fan speed (e.g., Static Fan %, for example 65% of a maximum fan speed in FIG. 7) in order to rapidly draw a higher level of humid air 16 from the IC engine 12 versus a lower fan speed during a normal run cycle mode or operation (e.g., Fan Speed %, for example 55% of the maximum fan speed in FIG. 7). It is understood different defaults or predetermined values may be used for the start-up mode to suit the particular application or environmental conditions as known by persons skilled in the art.

In one example of the method of operation 700 for the system 10 as shown in FIG. 21, if the humid air 16 as received from the interior of the IC engine 12 (i.e., the incoming humidity in FIG. 7) as measured at step 715 by the first sensor 122 (e.g., the first humidity sensor 122A) in the start-up cycle 710 is below a predetermined level (e.g., Humidity On, for example at 20% relative humidity (RH) in FIG. 7), the controller 130 deenergizes the at least one fan 119. At step 720, the at least one fan 119 remains deenergized until expiration of the predetermined time to initiate another start-up cycle 710 (e.g., 30 minutes, Static Fan Cycle in FIG. 7).

Still referring to FIG. 21, if the level of humidity of the humid air 16 as received from the IC engine 12 and measured by the first sensor 122 (e.g., the first humidity sensor 122A) during the start-up cycle 710 is above a predetermined level at step 725, for example above 20% relative humidity (e.g., Humidity On, for example at 20% in FIG. 7), the controller 130 may initiate a run cycle 730.

In one example of the run cycle 730, the system 10 (i.e., the dehydrator 50 and the at least one fan 119) will be energized by the controller 130 and run for a predetermined period of time (e.g., 5 minutes (m), 15 (m), 30 (m), 60 (m), or 120 (m)). It is understood that the predetermined run time may vary, longer or shorter, and in incremental values. In one example, time metrics may be displayed on the display panel 134 for the run time for the predetermined run cycle (e.g., Static Fan On, for example 30 minutes (m) in FIG. 7). It is understood that additional or alternate time metrics may be calculated and displayed on display panel 134 (e.g., how long the run cycle 730 has run and/or a countdown time until the run cycle 730 is stopped).

Still referring to the FIG. 21 example, in an alternate example of the run cycle 730, the controller 130 will keep the at least one fan 119 running until the humidity of the humid air 16 received from the IC engine 12 and as measured by the first sensor 122 (e.g., the first humidity sensor 122A) falls below a predetermined level (e.g., Humidity Off at 10% relative humidity in FIG. 7). In one example, when the humidity of the humid air 16 as measured falls below the predetermined level (e.g., 10% relative humidity in FIG. 7) at step 735, the controller 130 will deenergize (i.e., stop) the at least one fan 119 from running at step 740. In one example of the run cycle 730 shown as step 740, the controller 130 will keep the at least one fan 119 in a deenergized state for the predetermined time (e.g., 30 minutes, Static Fan Cycle in FIG. 7) before initiating the next start-up cycle 710 as generally shown and described above.

Still referring to the FIG. 21 example of the run cycle 730, if the measured humidity of the humid air 16 by the first sensor 122 remains above the predetermined level (e.g., Humidity Off at 10% relative humidity in FIG. 7) for a predetermined time (e.g., 60 minutes (m)) at step 745, the controller 130 will deenergize the at least one fan 119 for a predetermined period of time (e.g., 45 minutes (m)) at step 750.

In one example at step 755, the controller 130 is configured to raise the predetermined humidity level of the humid air 16 (as measured by the first sensor 122, for example first humidity sensor 122A) at which the at least one fan 119 is automatically stopped, a predetermined amount (e.g., 2%, for example raise the Humidity Off (FIG. 7) from 10% to 12%). Following expiration of the predetermined time in step 750, the controller 130 initiates a run cycle 730, but now at the raised predetermined humidity level (e.g., 12%) at which the at least one fan 119 is automatically stopped. It is understood that the raise in the predetermined amount (e.g., 2%) can be an alternate number, higher or lower (e.g., 1%, 3%, 5%, 10%, 15%, 20%), and in incremental amounts therebetween, to suit the particular application and/or as known by persons skilled in the art.

In one example, steps 730, 745, 750 and 755 will repeat until the measured humidity level of the humid air 16 by the first sensor 122 (e.g., first humidity sensor 122A) achieves the raised predetermined humidity level (i.e., Humidity Off in FIG. 7, for example at the raised 12% relative humidity). In one example, if the steps 730, 745, 750 and 755 are repeated a predetermined maximum number of times raising the predetermined humidity level (e.g., by 2%) without the measured humidity of the humid air 16 by the first sensor 122 (e.g., the first humidity sensor 122A) falling below the last raised predetermined relative humidity value (i.e., the raised Humidity Off in FIG. 7), the controller 130 will deenergize the at least one fan 119 and no further repetition of these steps will be made. In one example, an alert or alarm may be displayed on the display panel 134.

It is understood that the predetermined times and the predetermined humidity levels (e.g., Humidity On and Humidity Off in FIG. 7) can vary, both higher and lower, and in incremental values therebetween, as known by persons skilled in the art. In an alternate example, in addition to measuring and/or raising the predetermined humidity level that the at least one fan 119 is automatically shut off, the humidity of the dehumidified air 14 as measured by the second sensor 126 (e.g., the second humidity sensor 126A), can also be used and raised in steps 720, 735, 740 and 745. In an alternate example, in addition to measuring the humidity, the temperature of the humid air 16 as measured by the first sensor 122 and/or the temperature of the dehumidified air 14 as measured by the second sensor 126 may also be included in the above steps for method 700. In an alternate example, measurement of one or more of the other metrics described above may and comparison to predetermined values may be used in the start-up cycle 710 and/or the run cycle 730.

Although described that the run cycle 730 is initiated based on measurements of humidity and/or temperature in the start-up cycle 710, it is understood that the start-up cycle 710 may not be used. In other words, the run cycle 730 may be an independent or stand-alone preprogrammed mode and may, for example, be automatically initiated based on one of the predetermined time intervals described above (e.g., hourly, daily, weekly, monthly), or manually initiated by a user.

In one example, the predetermined time intervals between the start-up cycles 710 (e.g., Static Fan Cycle, for example 30 minutes (m) in FIG. 7) and/or the run cycles 730 may be based on a relative humidity and/or temperature of the ambient or environmental air surrounding the dehydrator 50 by one or more of the first sensor 122 and/or the second sensor 126 described, or an alternate dedicated temperature and/or humidity sensor or sensors (not shown) connected to the case 100 of the dehydrator 50. Alternately, the system 10 can be started and stopped manually by a user as described herein.

In an alternate example described below, a purge cycle mode or process 600 may be preprogrammed into controller 130 or may be manually run by a user.

In another example, the controller 130 may include other automatic modes or operations based on monitoring other metrics or factors. In one example, the controller 130 may be programmed to automatically stop or de-energize the at least one fan 119, for example if the at least one fan 119 is determined by a sensor to be at a temperature above a predetermined temperature, or in communication with the timer, has been running longer than a predetermined time, or as described above, the differential humidity 139 is below the predetermined level (e.g., 15% or 10%) after the dehydrator has been running for a predetermined time as noted in the examples above (e.g., which may indicate the dryer media 176 is no longer effectively removing humidity from the humid air 16).

In one example, a high temperature shut off mode may be preprogrammed into the controller 130 to deenergize the at least one fan 119. For example, a temperature sensor (e.g., first sensor 122) may measure the temperature of the humid air 16 received from the IC engine 12. If the temperature as measured exceeds a predetermined value (e.g., Temp Thresh in FIG. 7) that may damage the internal components of the dehydrator 50, the controller 130 may automatically deenergize the at least one fan 119. Other automatic modes, actuations or operations, and/or predetermined times or humidity or temperature levels, may be used as known by persons skilled in the art.

It is understood that the controller 130 may have alternate preprogrammed activation or run cycles, or modes of operation and/or may be based on alternate metrics or predetermined levels for energizing and de-energizing the dehydrator 50 based on the particular application (e.g., the type of IC engine 12), the environment (e.g., geographic location of higher temperature or higher humidity) or other metrics or factors as known by persons skilled in the art. In an alternate example, the dehydrator 50 and controller 130 may be manually operated by a user, e.g., the user manually starts or energizes, and deenergizes or stops operation of, the dehydrator 50 through an activation switch, push button or other actuator.

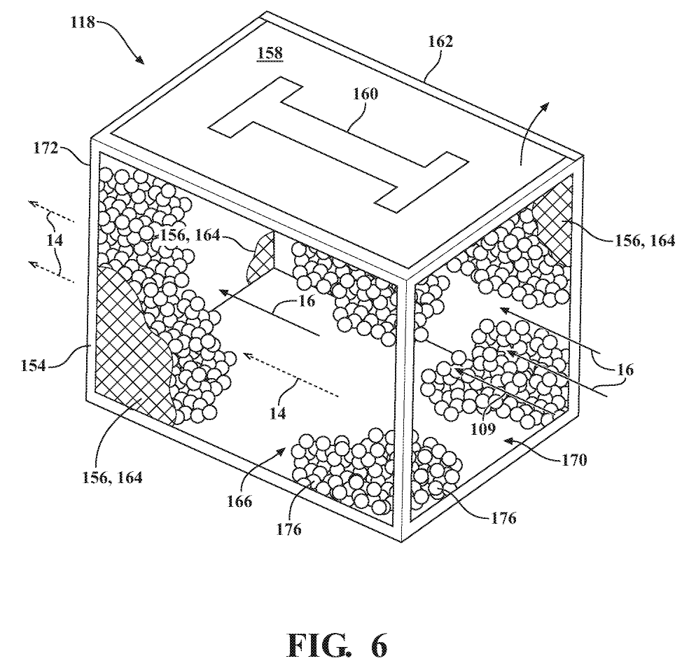

Referring to FIG. 6, an example of the dryer cartridge 118 is shown. In the example, the dryer cartridge 118 includes a frame 154 having a plurality of sidewalls 156 defined by or connected to the frame 153 defining a cavity 166. At least two sidewalls of the plurality of sidewalls 156 are oriented transverse to the air pathway 109 and are configured to allow the humid air 16 and the dehumidified air 14 to pass through respective of the at least two sidewalls. In one example, the at least two sidewalls are respectively positioned at a first end 170 and a second end 172 of the dryer cartridge 118. In the example, the dryer cartridge 118 includes a cover 158 connected to the frame 154 and is movable or removable relative to the plurality of sidewalls 156.

A dryer media 176 is positioned in the cavity 166 and is configured to remove humidity from the humid air 16 that is forced through the dryer cartridge 118 along the air pathway 109 by the at least one fan 119. In one example, the cover 158 is configured to allow the dryer media 176 to be removed from the dryer cartridge 118 in order to be reactivated (i.e., the moisture absorbed by the dryer media 176 is removed or evaporated) or replaced with new or alternate dryer media 176.

The cover 158 may include a handle 160 for movement of cover 158 relative to the frame 154 or to transport or carry the dryer cartridge 118 away from the dehydrator 50. In one example, a hinge 162 is connected to the cover 158 and the frame 154 allowing selective rotation of the cover 158 relative to the frame 154. A latch or lock (not shown) may be used to secure or lock the cover 158 in a closed position (as shown in FIG. 6) preventing rotation of the cover 158 relative to the frame 154.

In one example, the plurality of sidewalls 156 (e.g., the four vertical sides and the bottom) may each be formed from a mesh material 164 (e.g., highly perforated) providing exposure to and configured to allow the humid air 16 to pass through the plurality of sidewalls 156 into and out of the cavity 166. In one example, the at least two sidewalls (e.g., the first end 170 and the second end 172) of the plurality of sidewalls 156 are made from the mesh material. In one example, the cover 168 is also made from the mesh material. It is understood that less than all of the plurality of sidewalls 156 are made from the mesh material. In one example, one or more of the plurality of sidewalls 156 and/or the cover 158 are made from an alternate material, for example a solid panel (e.g., aluminum or steel).

In one example, exterior dimensions of the frame 154 are sized in order for the dryer cartridge 118 to be positioned within the interior cavity 116 of the case 100 as best seen in FIGS. 4, 5 and 6. In one example, the frame 154, the plurality of sidewalls 156, the mesh material 164, and the cover 158 are made from a heat resistant metal, for example steel or aluminum. In an alternate example (not shown), the cover 158 is not used and the mesh material is secured to the frame 154 by fasteners (e.g., screws or other mechanical fasteners). If the dryer media 176 needs to be removed, a mesh panel may be disconnected from the frame 154 by the fasteners and reconnected when the dryer media 176 is reactivated or replaced. It is understood that alternate structures, components, configurations, sizes, shapes, and materials of the dryer cartridge 118 may be used to suit the particular application and performance requirements as known by persons skilled in the art.

In one example, the dryer media 176 is a pelletized or granular material configured to remove the humidity (i.e., moisture or water vapor) from the humid air 16 moved along the air pathway 109 through the dryer cartridge 118 in the case 100. In one example, the dryer media is desiccant. In the example, the desiccant removes the humidity from the air through absorption into the desiccant. In one example, the desiccant changes color as more humidity is absorbed providing a visual indication as to its state of humidity absorption effectiveness (e.g., fresh/dry versus saturated and in need of reactivation). A common method of removing the absorbed humidity is to thermally heat the desiccant which releases absorbed humidity and thereby reactivates the desiccant for reuse to absorb additional humidity. It is understood that other materials may be used for dryer media 176 which serve to absorb moisture from static air or a flow of air as known by persons skilled in the art.

In one example described above, the frame 154, the plurality of sidewalls 156, and the cover 158 are made from a heat resistant metal. In one example, the dryer cartridge 118, including the dryer media 176 positioned in the cavity 166, is selectively removable as a single unit (e.g., FIG. 6) from the interior cavity 116 defined by the first wall 110, the second wall 114, and the outer wall 104 of the housing 102, in order for the dryer media 176 to be reactivated while remaining in the dryer cartridge 118. In one example, the dryer cartridge 118 may be removed from the case 100 as a single unit, placed in a heating device (not shown), for example a common household oven, heated to reactivate the dryer media 176 (e.g., remove the absorbed humidity from the desiccant), allowed to cool, and then reinstalled in the interior cavity 116 of the case 100 for reuse. In an alternate example, the dryer media 176 can be removed from the dryer cartridge 118, reactivated, and reinstalled in the dryer cartridge 118. In an alternate example, the dryer media 176 can be replaced with new or an alternate form of dryer media 176. In an alternate example of the system 10 (not shown), the removable dryer cartridge 118 is not used. In the example, the dryer media 176 is simply added into the interior cavity 116 of the housing 102 and contained within the housing 102 by the outer wall, 104, the first wall 110, the second wall 114, and the lid 107.

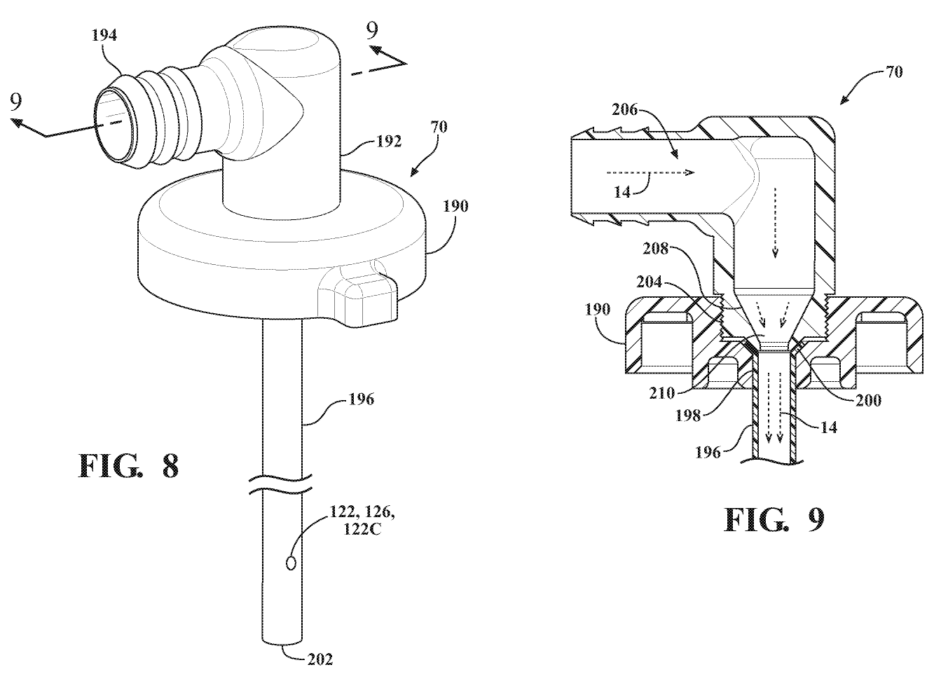

Referring to FIGS. 8 and 9, an example of the oil filler fitting 70 for use in the system 10 is shown. In one example, the oil filler fitting 70 is sealingly connected to the air outlet tube 58 and the oil filler port 22 to transfer at least a portion of the dehumidified air 14 received from the dehydrator 50 to the IC engine 12 through the oil filler port 22 of the IC engine 12 to circulate the dehumidified air 14 through the interior of the IC engine 12. In the example, the oil filler fitting 70 includes a base 190 configured to sealingly connect to the oil filler port 22 of the IC engine 12. In one example, a seal (not shown) is connected to the base 190 to assist in creating an airtight, or substantially airtight, connection between the base 190 and the oil filler port 22. An inlet 194 is connected to the base 190 and is configured to sealingly connect to the air outlet tube 58. The inlet 194 defines a first air passage 206 through the inlet 194 in communication with the air outlet tube 58.

In the example as best shown in FIG. 9, a constrictor 208 is positioned along the first air passage 206 defining a second air passage 210 that is smaller in an internal diameter (or internal dimension) than the first air passage 206. The constrictor 208 is configured to increase a velocity of the dehumidified air 14 received from the air outlet tube 58 creating a forced or more focused jet of dehumidified air 14 into the IC engine 12. The oil filler fitting 70 further includes an elongate down tube 196 having a first end 198 engaged with the base 190 and a second end 202 configured to be positioned proximate the reservoir oil level 25 in the oil sump 24 of the IC engine 12 for transfer of the dehumidified air 14 to the oil sump 24 of the IC engine 12 as best seen in FIG. 1.

In one example, the elongate down tube 196 is configured such that the second end 202 is positioned two (2) inches vertically above the reservoir oil level 25. It is understood that the elongate down tube 196 can be alternately configured to position the second end 202 in an alternate location or position relative to the oil sump 24 and/or the reservoir oil level 25, both vertically closer to the reservoir oil level 25 (e.g., one (1) inch or increments therebetween) or vertically further away (e.g., 2.5 inches, 3 inches or more, and increments therebetween) to suit the particular application (e.g., type of IC engine 12). The extended configuration of the elongate down tube 196 down toward the oil sump 24 and positioning of the second end 202 proximate the reservoir oil level 25 is advantageous so that the dehumidified air 14 is transferred and focused directly to the oil sump 24 where humidity is typically high and IC engine 12 components that are particularly susceptible to moisture corrosion are positioned in that general area of the IC engine 12.

By directing and forcing the dehumidified air 14 directly to and exited in close proximity of the oil sump 24 (see FIG. 1), the dehumidified air 14 absorbs typically higher humidity in this area of the IC engine 12 (changing the dehumidified air 14 into humid air 16 as generally depicted by the different arrows in FIG. 1). Additionally, the directed and forced dehumidified air 14 to the oil sump 24 also, through forced air flow and/or air pressure, forces the existing humid air 16, and forces the hot or higher temperature air, in this lower area of the IC engine 12 toward the oil breather pipe 46 which serves as the air evacuation point of the humid air 16 which is drawn from the IC engine 12 by the at least one fan 119 (e.g., the first fan 120 and the second fan 124) into the dehydrator 50 wherein the humidity from the humid air 16 is removed by the dryer cartridge 118. These IC engine 12 conditions, and advantages of the system 10, are particularly, but not exclusively, beneficial when the IC engine 12 is hot (e.g., when an aircraft having the IC engine 12 has recently flown or been in use).

Referring to the oil filler fitting 70 example in FIG. 9, the base 190 and the inlet 194 are separate pieces each having a threaded portion 204 for cooperatingly engaging and sealing connection of the inlet 194 to the base 190. In the example, the elongate down tube 196 includes a flared end 200 (i.e., radially extending outward) at the first end 198 as generally shown. In an alternate example, the base 190 and the inlet 194 are integral or formed as a single piece. The flared end 200 assists in increasing the velocity of the dehumidified air 14 and prevents the elongate down tube 196 from disengaging from the base 190 and falling into the IC engine 12. In the example shown in FIG. 9, the flared end 200 is positioned or sandwiched between the top 192 and the base 200. In one example, the base 190, the inlet 194 and the elongate down tube 196 are made from a heat resistant polymer or elastomer. In one example, the elongate down tube 196 is a flexible hollow tube. It is understood that other configurations, components, sizes, shapes, dimensions, and materials for the oil filler fitting 70 may be used to suit the particular application and performance requirements as known by persons skilled in the art.

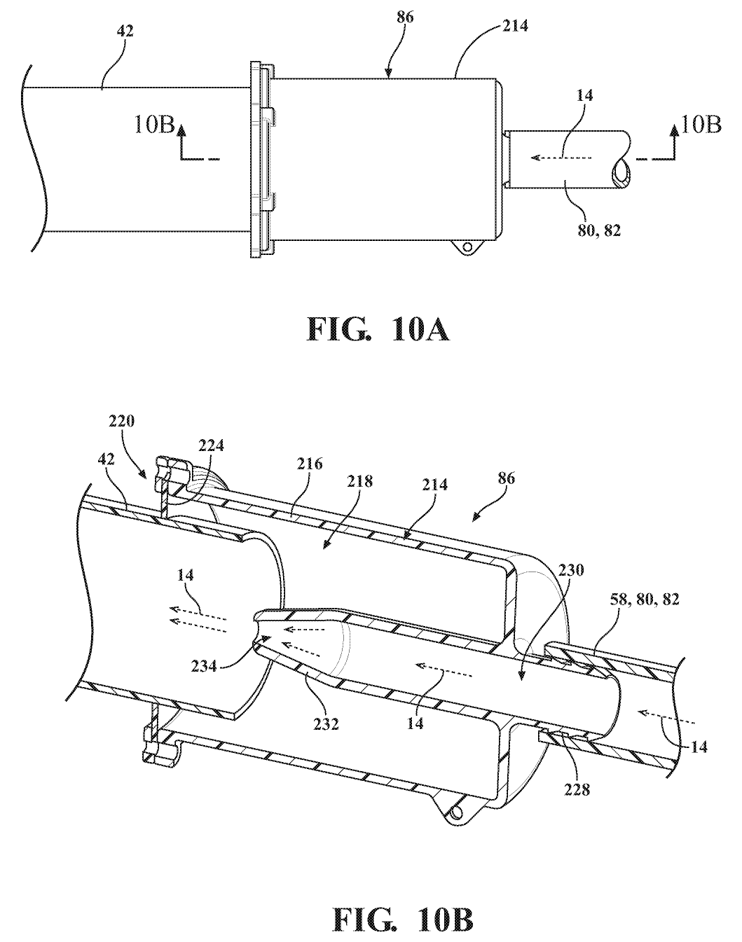

Referring to FIGS. 10A and 10B, an example of the exhaust fitting 86 for use in the system 10 is shown. The exhaust fitting 86 is configured to transfer at least a portion of the dehumidified air 14 from the dehydrator 50 into the IC engine 12 through the exhaust pipe 42. As best seen in the FIG. 10B example, the exhaust fitting 86 includes a base 214 having a seal 224 configured to sealingly engage the exhaust pipe 42. An inlet 228 is connected to the base 214 and is configured to sealingly connect to the air outlet tube 58 (or the second air outlet tube 74, or the first exhaust outlet tube 80 or the second exhaust outlet tube 82) depending on the configuration of the system 10 (e.g., as shown in the FIG. 1 example). The inlet 228 defines a first air passage 230 through the inlet 228 in communication with the air outlet tube 58. The exhaust fitting 86 further includes a constrictor 232 positioned along the first air passage 230. The constrictor 232 defines a second air passage 234 that is smaller than the first air passage 230 (e.g., in internal diameter or internal dimension) and is configured to increase a velocity of the dehumidified air 14 received from the air outlet tube 58 for transfer of the dehumidified air 14 to the cylinders 20 of the IC engine 12 (FIG. 2).

In the example, the base 214 includes an outer wall 216 defining a cavity 218 and an air exit end 220. The air exit end 220 and the cavity 218 are configured to receive a portion of the exhaust pipe 42 as generally shown. In one example, the seal 224 is positioned on an inner wall of the outer wall 216 and radially extends into the cavity 218. In an alternate example (not shown), the seal 224 may be positioned on the longitudinal end of the air exit end 220. On receipt of the exhaust pipe 42 into the cavity 218, the seal 224 engages the exhaust pipe 42 forming an airtight, or substantially airtight, seal between the exhaust fitting 86 and the exhaust pipe 42. As best seen in the FIG. 10A example, the inlet 228 of the exhaust fitting 86 sealingly engages with the air outlet tube 58. The exhaust fitting 86 may be made from the same material as the oil filler fitting 70 as described above. It is understood that the exhaust fitting 86 may take other configurations, sizes, shapes and be made from different materials to suit the particular application and performance requirements as known by those skilled in the art.

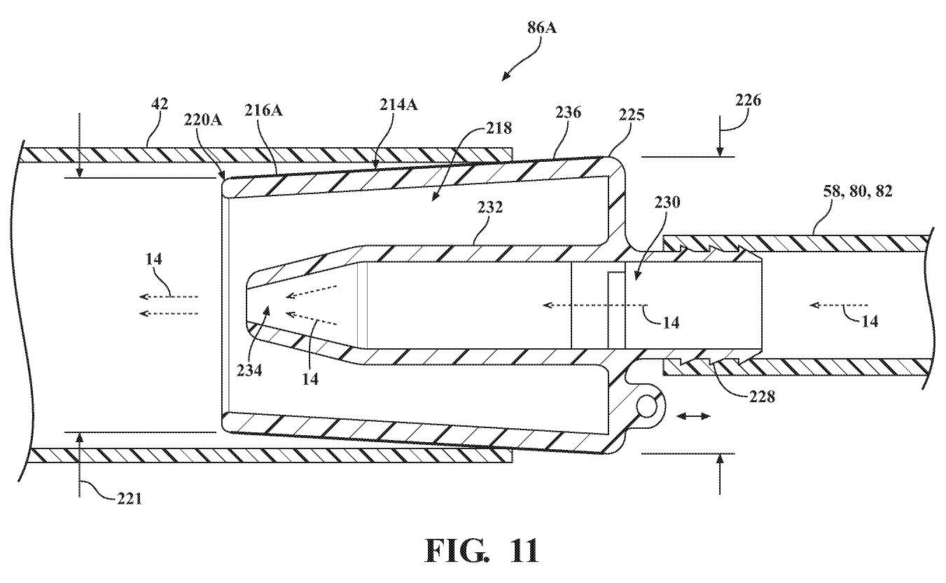

Referring to FIG. 11, an alternate example of the exhaust fitting 86A is shown. In the FIG. 11 example, the same reference numbers for FIGS. 10A and 10B are used where the component is the same or substantially the same as described for FIGS. 10A and 10B. In the FIG. 11 example, the exhaust fitting 86A is configured and used as a plug-type fitting that is installed and frictionally engaged with an inside wall or inside diameter of the exhaust pipe 42 versus the example of the exhaust fitting 86 in FIGS. 10A and 10B which is installed and engaged around the outer wall or the outer diameter of the exhaust pipe 42 as generally shown.

Referring to the FIG. 11 example, the exhaust fitting 86A includes a base 214A and is configured to frictionally and sealingly engage the exhaust pipe 42. The inlet 228 is connected to the base 214A and is configured to sealingly connect to the air outlet tube 58 (or the second air outlet tube 74, or the first air outlet tube 80 or the second air outlet tube 82) depending on the configuration of the system 10 (e.g., as shown in the FIG. 1 example). The inlet 228 defines the first air passage 230 through the inlet 228 in communication with the air outlet tube 58. The exhaust fitting 86A further includes the constrictor 232 positioned along the first air passage 230 and defines the second air passage 234 to increase the velocity of the dehumidified air 14 as generally described above for the exhaust fitting 86.

In the FIG. 11 example, the base 214A includes an outer wall 216A defining the cavity 218. The outer wall 216A includes an air exit end 220A having an outer diameter 221 and an air inlet end 225 having an outer diameter 226 as generally shown. In the example, the outer diameter 221 of the air exit end 220A is smaller than the outer diameter 226 of the air inlet end 225 forming a tapered or a frustoconical configuration or shape as generally shown. In the example shown, the exhaust fitting 86A is installed onto or engaged with the exhaust pipe 42 by inserting the air exit end 220A into the inside of the exhaust pipe 42 until a portion of the outer wall 216A frictionally and sealingly, or substantially sealingly, engages the inside of the exhaust pipe 42 as generally shown.

In the FIG. 11 example, an exterior surface of the outer wall 216A includes a coating 236 which assists and facilitates the frictional and sealing engagement of the outer wall 216A with the inside of the exhaust pipe 42. In one example, the coating 236 includes a high temperature resistant rubber or elastomer which provides for secure and sealing engagement of the exhaust fitting 86A to the exhaust pipe 42 in the manner described preventing, or substantially preventing, the flow of dehumidified air 14 from passing between the outer wall 216A and the exhaust pipe 42 while allowing the exhaust fitting 86A to be removable from the exhaust pipe 42 without damaging the exhaust fitting 86A or the exhaust pipe 42. It is understood that the exhaust fitting 86A can take other configurations, shapes, sizes, and dimensions, and be made of alternate materials, to suit the particular application as known by persons skilled in the art. In an alternate example (not shown), the exhaust fitting 86A may be removably connected to and sealingly engaged with the exhaust pipe 42 in an alternate manner, for example a radial seal (e.g., seal 224 radially extending outward from the outer wall 216A) and/or mechanical clip or fastener.

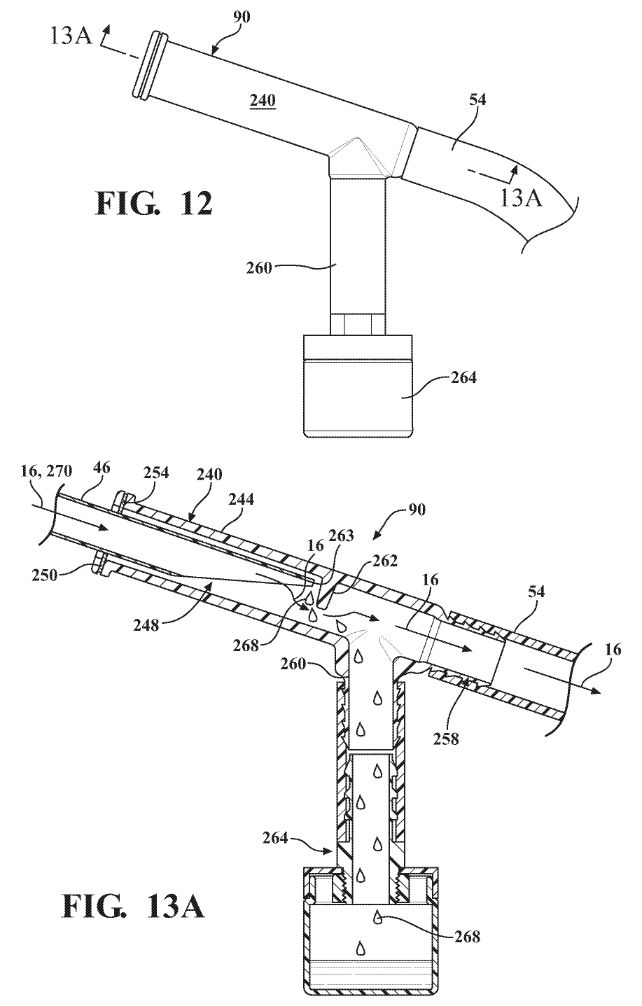

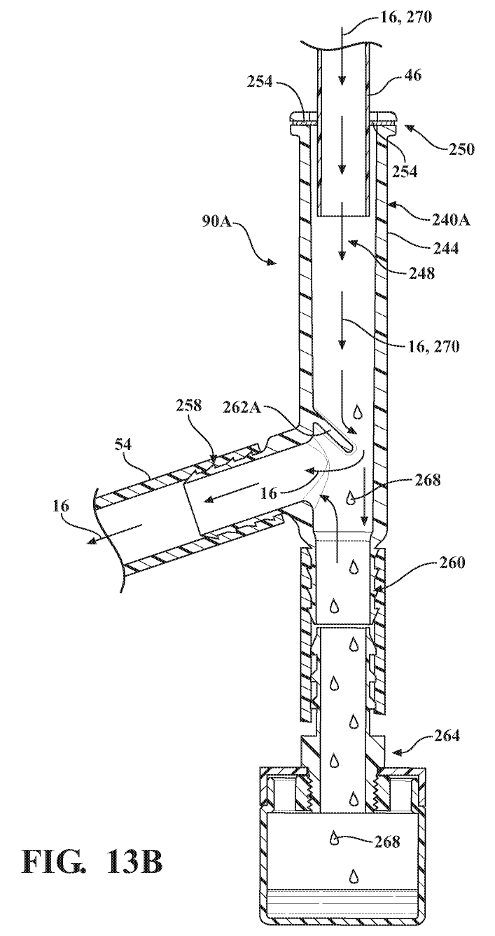

Referring to FIGS. 12, 13A and 13B, examples of the oil breather pipe fitting 90 for use in the system 10 are shown. The oil breather pipe fitting 90, 90A is configured to connect to the oil breather pipe 46 and transfer the humid air 16 from the interior of the IC engine 12 to the dehydrator 50.

In the example shown in FIGS. 12 and 13A, the oil breather pipe fitting 90 includes a body 240 having an outer wall 244 defining an air passage 248. An air inlet end 250 is in communication with the air passage 248 and includes a seal 254 configured to sealingly engage the oil breather pipe 46. An air outlet end 258 is in communication with the air passage 248 and is configured to sealingly connect with the air inlet tube 54. A drain outlet 260 is in communication with the air passage 248 extending downward from the outer wall 244 as generally shown. In the example as best seen in FIG. 13A wherein the oil breather pipe fitting 90 is used with an IC engine 12 oriented at an angle relative to the IC engine 12 (e.g., at 45 degrees relative to a bottom end of the IC engine 12), the drain outlet 260 is oriented at an angle relative to the body 240. In one example, the angle is 45 degrees relative to the body 240 or a longitudinal axis of the body 240. It is understood that the angle can be a different angle, both larger and smaller, to suit the particular application, for example the orientation of the oil breather pipe 46 relative to the IC engine 12. In one example, the drain outlet 260 is oriented along a vertical direction (i.e., in the direction of gravity).

Although the oil breather pipe 46 is shown at an angle of approximately 45 degrees relative to the IC engine 12, it is understood that different configurations of the IC engine 12 may have different configurations or angle of the oil breather pipe 46, both at an outlet end where the oil breather pipe fitting 90 is connected, or at the connection to the IC engine 12 (e.g., at the oil filler port 22) as known by persons skilled in the art. In one alternate example as shown in FIG. 13B the oil breather pipe 46 may be oriented at a 90 degree angle (i.e., vertical direction) relative to the bottom of the IC engine 12.

In the FIG. 13A example, the oil breather pipe fitting includes a vane 262 (e.g., an oil drip ring) extending radially inward from the body 240 into the air passage 248 as generally shown. In one example of the IC engine 12 in the form of an aircraft engine, it is common in aircraft engines that due to air flow and air pressure during flight, a small amount of liquid oil 268 tends to collect on the upper surface of the inside of the oil breather pipe 46. When the aircraft engine stops or is placed at rest, the small collection of liquid oil 268 drips downward under the force of gravity toward a tip 263 of the oil breather pipe 46. The vane 262 prevents the liquid oil 268 from continuing downward toward the air inlet tube 54. The vane 262 diverts the liquid oil 268 downward such that the liquid oil 268 collects and drips or falls under the force of gravity toward the drain outlet 260 as generally shown.

The vane 262 also alters the flow and direction of the humid air 16 and oil vapor 270 therein as generally shown. The diversion of the humid air 16 also assists to accumulate or collect the liquid oil 268 present in the oil vapor 270 onto the vane 262 such that the liquid oil 268 falls under the force of gravity toward the drain outlet 260 as described above.

In the FIGS. 13A and 13B examples, a bottle 264 is sealingly and removably connected to the drain outlet 260 and is configured to receive and store the liquid oil 268 that is diverted by the vane 262 as described above.

Referring to the FIG. 13B example, the oil breather pipe fitting 90A is shown in an alternate configuration and used in applications where the IC engine 12 includes the oil breather pipe 46 in a vertical or substantially vertical orientation relative to the IC engine 12. The same reference numbers and descriptions as used for FIG. 13A are also applicable and used for the same, or substantially the same, components unless otherwise noted. In the FIG. 13B example, the oil breather pipe fitting 90A orients the drain outlet 260 downward (e.g., vertical) and the air outlet end 258 is oriented at an angle relative to the body 240A as generally shown. In one example, the air outlet end 258 is oriented at a 45 degree angle relative to the body 240A. It is understood that other angles for the air outlet end 258 relative to the body 240 may be used to suit the particular application or configuration of the IC engine 12.

In the FIG. 13B example, the oil breather pipe fitting 90A includes the vane 262A extending radially inward from the body 240 into the air passage 248 as generally shown. The vane 262A alters the flow and direction of the humid air 16 (and the oil vapor 270 therein) as generally described above in FIGS. 13A in a manner as generally shown in FIG. 13B. As generally described above for FIG. 13A, due to the change in the direction of the air flow of the humid air 16 due to the vane 262A, the vane 262A facilitates the suspended oil particulates (illustrated as liquid oil 268) to separate from the humid air 16 and from the oil vapor 270 and fall under the force of gravity toward and into the drain outlet 260 and into the bottle 264 as generally shown.

It is understood that the vane 262 and the vane 262A may be positioned in alternate locations in the air passage 248, and may be alternately orientated relative to the body 240, 240A (e.g., at an alternate angle than illustrated) to suit the particular application, for example where the oil breather pipe 46 is oriented at a different angle relative to the IC engine 12 as described in the example above. It is further understood that the vane 262 and the vane 262A can take alternate configurations, dimensions, shapes, and positions and/or orientations relative to the body 240, 240A other than as illustrated to suit the particular application as known by persons skilled in the art. In one example (not shown), the vane 262 and the vane 262A are not used.

In one example, the seal 254 of oil breather pipe fitting 90, 90A (referred to below simply as the oil breather pipe fitting 90 unless otherwise noted) is positioned on an inner wall of the outer wall 244 and radially extends into the air passage 248 as generally shown. In an alternate example, the seal 254 may be positioned on the longitudinal end of the air inlet end 250. On receipt of the oil breather pipe 46 into the air inlet end 250, the seal 254 sealing engages the oil breather pipe 46 forming an airtight, or substantially airtight, seal between the oil breather pipe fitting 90 and the oil breather pipe 46. The air outlet end 258 is configured to sealingly engage the air inlet tube 54 forming an airtight, or substantially airtight, connection between the oil breather pipe fitting 90 and the air inlet tube 54. In one example, the drain outlet 260 and the bottle 264 are not used in the oil breather pipe fitting 90, 90A.

The oil breather pipe fitting 90, 90A may be formed from the same materials as described for the oil filler fitting 70. It is understood that the oil breather pipe fitting 90 may take other forms, configurations, sizes, shapes, orientations of component features, and/or dimensions, and may be made from other materials, to suit the application and/or configuration of the IC engine 12 as known by persons skilled in the art.

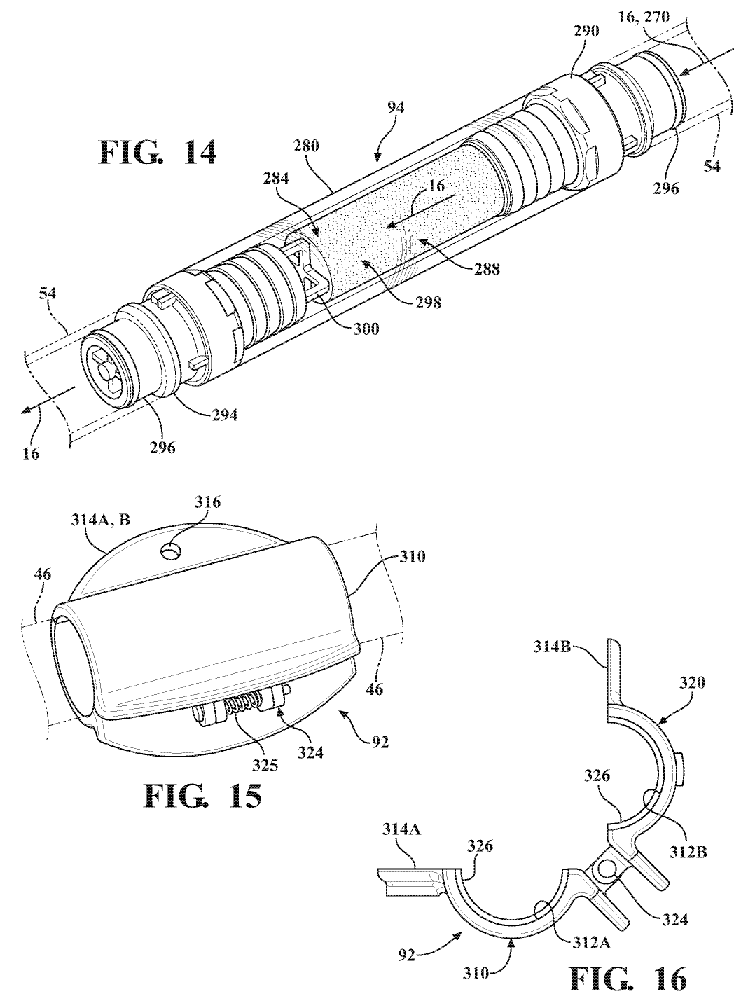

Referring to FIG. 14, an example of the oil particulate filter 94 for use in the system 10 is shown. In use of the system 10, the return of humid air 16 from the IC engine 12 may include liquid oil particulate or oil vapor suspended in the humid air 16 traveling through the air inlet tube 54 toward the dehydrator 50. It is advantageous to collect and filter out the liquid oil particulate from the humid air 16 prior to the humid air 16 entering the dehydrator 50 and into the dryer cartridge 118 which may collect on the dryer media 176, foul or contaminate the dryer media 176, reduce the humidity absorption capability of the dryer media 176, and/or make the dryer media 176 difficult to reactive.

In the FIG. 14 example and as seen in FIG. 1, the oil particulate filter 94 is positioned downstream of the oil breather pipe 46, and upstream of the dehydrator 50. The oil particulate filter 94 is positioned in communication with the air inlet tube 54. The oil particulate filter 94 includes a body 280 defining a cavity 284 and an air passage 288 configured to receive and transfer the humid air 16 from the IC engine 12. An inlet cap 290 is sealingly connected to the body 280 upstream of the cavity 284. An outlet cap 294 is sealingly connected to the body 280 downstream of the cavity 284. In one example, a filter 298 is positioned in the cavity 284 transverse to a flow of the humid air 16 received for the IC engine 12 through the cavity 284 along the air passage 288 in the body 280. The filter 298 is configured to capture and retain the liquid oil particulate in the humid air 16 (including the oil vapor 270) upstream of the air inlet 105 of the dehydrator 50.

In one example, the filter 298 may be made from sintered bronze, be coalescing-type or material, activated carbon, microfiber glass fiber or media, pleated, or other materials that are effective for removing oil vapor and/or oil particulate from air while allowing the humid air 16 to easily pass through the filter 298 while catching and holding the oil vapor 270 and/or liquid oil particulate. It is understood that filter 298 may take other forms, configurations, shapes, sizes and may be made from other materials as known by persons skilled in the art.

As best seen in the FIG. 14 example, the body 280 may be a hollow cylindrical tube which sealingly connects to the inlet cap 290 and the outlet cap 294 forming an airtight, or substantially airtight, connection. In one example, the body 280 is formed from a clear or transparent polymer material such that the filter 298 may be visually seen to determine if the filter 298 requires replacement. In one example, either the inlet cap 290 and/or the outlet cap 294 may be disengaged from the body 280 for removal from the body 280 for replacement or cleaning of the filter 298.

In one example (not shown) the first sensor 122 may include a sensor, for example an airflow or air pressure sensor, configured to monitor the condition of the filter 298. In one example, the sensor is in communication with the controller 130 as described above for the first sensor 122. In the example of the sensor detecting airflow through the body 280 downstream of the filter 298, if the airflow as measured falls below a predetermined value, which is indicative that the filter 298 is need of cleaning or replacement, the controller 130 can, for example, display the value as measured on the GUI of display 134 and/or display or otherwise indicate an alarm or other notice to a user.

In the FIG. 14 example, the inlet cap 290 and the outlet cap 294 sealingly engage ends of the air inlet tube 54 as generally shown. In one example, each of the inlet cap 290 and the outlet cap 294 include a seal 296, for example an o-ring seal, to sealingly engage the respective end of air inlet tube 54. In one example, a stop 300 may be positioned in the cavity 284 between the filter 298 and the outlet cap 294 to maintain a longitudinal position of the filter 298 within the cavity 284, or a configuration or position relative to the body 280 and the cavity 284, such that the filter 298 is best positioned such that the humid air 16 flows through the filter 298 and the filter 298 does not substantially obstruct the air passage 288 to the outlet cap 294. It is understood that the stop 300 may not be used.

It is understood that the oil particulate filter 94 and the filter 298 may take alternate configurations, components, sizes, shapes, and/or orientations and locations with respect to the air inlet tube 54, and be made from different materials to suit the particular application and performance requirements as known by persons skilled in the art. In one example of system 10, the oil particulate filter 94 is not used.

Referring to FIGS. 15 and 16, an example of the clip 92 for use in the system 10 is shown. In the example the clip 92 is configured to seal an ice hole aperture 306 in the oil breather pipe 46 as best seen in FIG. 2. In the example, the clip 92 includes a first part 310 having an inner wall 312A and a first flange 314A, and a second part 320 having an inner wall 312B and a second flange 314B.

A hinge 324 is connected to the first part 310 and the second part 320 and is configured to allow the first part 310 to angularly or rotatably move about the hinge 324 relative to the second part 320 (or vice versa). In one example, the first flange 314A and the second flange 314B each include an aperture 316 as generally shown. As best seen in the FIG. 15 example, a biasing member 325, for example a coil spring, is engaged with the first part 310 and the second part 320 to bias the first part 310 and the second part 320 toward one another, for example as shown in FIG. 15. The biasing member 325 can take other forms, configurations, and positions relative to the first part 310 and the second part 320 as known by persons skilled in the art. In one example of clip 92, the biasing member 325 is not used.

As best seen in the FIG. 16 example, a seal 326 is connected to an inside surface of the inner wall 312A and the inner wall 312B as generally shown. In one example, the seal 326 is a layer of high temperature resistant rubber or foam. In an alternate example, the seal 326 is integral to the inner wall 312A, 312B. It is understood that the seal 326 can be included in only one of the first part 310 or the second part 320, and can take other forms, shapes, sizes and locations, and be made from different materials, as known by persons skilled in the art.

On installation of the clip 92 to the oil breather pipe 46, and the first flange 314A and the second flange 314B being positioned adjacent to one another, the inner wall 312A of the first part 310 or the inner wall 312B of the second part 320 are configured to wrap around an outside of the oil breather pipe 46 and the seal 326 is positioned and configured to seal the ice hole aperture 306 preventing humid air 16 from passing through the ice hole aperture 306.

In one example of the clip 92, a fastener (not shown) may be positioned in the aperture 316 preventing the first part 310 from moving relative to the second part 320 thereby securing the clip 92 in place relative to the oil breather pipe 46 and the ice hole aperture 306. In one example, a seal or layer of seal material (not shown) may be connected to the inner wall 312A and/or the inner wall 312B. The clip 92 may be made from the material described for the oil filler fitting 70. It is understood that clip 92 may take other forms, configurations, sizes, shapes, components or constructions, and may be made from other materials, as known by persons skilled in the art.

Referring generally to FIGS. 1, 2 and 3, in one example of use of the system 10, the IC engine 12 may include only one of the exhaust pipe 42 (e.g., the first exhaust pipe 43 or the second exhaust pipe 44). In use of system 10 on the IC engine 12 in this example configuration, the system 10 may be configured to include the air outlet tube 58 sealingly connected to the dehydrator 50, for example the second fan 124 at the air outlet 106 of the case 100 or a fitting (not shown) connected to the outer wall 104 of the case 100. In the example, the air outlet tube 58 includes the first valve 62 positioned between the air outlet 106 of the case 100 and the oil filler port 22 and the exhaust pipe 42. The first valve 62 includes an air inlet end 328 in communication with the air pathway 109 of the case 100. The air outlet tube 58 includes the first air outlet tube 66 sealingly connected to the first valve 62 and is in communication with the oil filler port 22 and is configured to transfer the dehumidified air 14 received from the dehydrator 50 to the oil filler port 22.

The air outlet tube 58 includes the second air outlet tube 74 sealingly connected to the first valve 62 and in communication with the exhaust pipe 42 and is configured to transfer the dehumidified air 14 received from the dehydrator 50 to the exhaust pipe 42. The first valve 62 is configured to selectively adjust a flow of the dehumidified air 14 received from the dehydrator 50 through the first air outlet tube 66 to the oil filler port 22 and through the second air outlet tube 74 to the exhaust pipe 42. In one example of the first valve 62, the first valve 62 includes a first position where both of the first air outlet tube 66 and the second air outlet tube 74 are open allowing the flow of dehumidified air 14 to both of the oil filler port 22 and the exhaust pipe 42, a second position to close the second air outlet tube 74 and direct the flow of dehumidified air 14 to the oil filler port 22, or a third position to close the first air outlet tube 66 and direct the flow of dehumidified air 14 to the exhaust pipe 42.

In an alternate example, the first valve 62 may be positioned to partially open or close the flow of the dehumidified air 14 through the first air outlet tube 66 and/or the second air outlet tube 74. Other configurations, constructions, positions for air flow, and operations of the first valve 62 may be used as known by persons skilled in the art.

Referring to the system 10 example shown in FIGS. 1-3, the IC engine 12 is configured to include the first exhaust pipe 43 and the second exhaust pipe 44. In use on this IC engine 12 configuration, the system 10 includes the air outlet tube 58, the first valve 62, the first air outlet tube 66, and the second air outlet tube 74 as described above. In this example wherein the IC engine 12 includes the first exhaust pipe 43 and the second exhaust pipe 44, the second air outlet tube 74 includes the second valve 78 including an exhaust air inlet 332 in communication with the second air outlet tube 74.

The second air outlet tube 74 includes the first exhaust outlet tube 80 in communication with the first exhaust pipe 43 and is configured to transfer a portion of the dehumidified air 14 received from the dehydrator 50 to the first exhaust pipe 43. The second air outlet tube 74 further includes the second exhaust outlet tube 82 in communication with the second exhaust pipe 44 and is configured to transfer a portion the dehumidified air 14 received from the dehydrator 50 to the second exhaust pipe 44.

In one example of the second valve 78, the second valve 78 includes a first position where both of the first exhaust outlet tube 80 and the second exhaust outlet tube 82 are open allowing the flow of dehumidified air 14 to both of the first exhaust pipe 43 and the second exhaust pipe 44, a second position to close the second exhaust outlet tube 82 and direct the flow of dehumidified air 14 to the first exhaust outlet tube 80, and a third position to close the first exhaust outlet tube 80 and direct the flow of dehumidified air 14 to the second exhaust outlet tube 82. In an alternate example, the second valve 78 may be configured to partially open or partially close, or completely close, the flow of the dehumidified air 14 to the first exhaust outlet tube 80 and/or the second exhaust outlet tube 82. Other configurations, constructions, and operations of the second valve 78 may be used as known by persons skilled in art. In an alternate example of system 10, the first valve 62 and/or the second valve 78 may not be valves, or selectable position valves, to control or direct the flow of the dehumidified air 14, but may be configured as “T” joints or “Y” shaped joints or connectors which are always open allowing air flow to the connected air tubes. In one example, the air inlet tube 54 and the air outlet tube 58 are hollow tubes or pipes made from a flexible material, for example flexible polyvinyl chloride (PVC). It is understood that the air inlet tube 54 and the air outlet tube 58 may be made from alternate materials and take alternate configurations and constructions as known by persons skilled in the art.

It is understood that in both alternate configurations of the IC engine 12 (i.e., one exhaust pipe or two exhaust pipes), that the system 10 may be configured to include the second valve 78 and the first exhaust outlet tube 80 and the second exhaust outlet tube 82. When used with an IC engine having only one of the exhaust pipe 42, only one of the first exhaust outlet tube 80 or the second exhaust outlet tube 82 can be connected to the exhaust pipe 42 and the second valve 78 positioned to close the exhaust outlet tube that is not connected to the exhaust pipe 42. This configuration of system 10 allows flexibility for use on alternately configured IC engines 12. In an alternate example of system 10 for use on an IC engine that includes only one of exhaust pipe 42, the air outlet tube 58 can include the first air outlet tube 66, the first valve 62 and only the second air outlet tube 74 which connects to the exhaust pipe 42 in the manners described above.

In an alternate example of the system 10, the first valve 62 and the second valve 78 are not used. In the example, the first air outlet tube 66 and the second air outlet tube 74 each independently connect to a separate air outlet of the dehydrator 50. It is understood that the air inlet tube 54 and the air outlet tube 58, and associated tubes described herein to transfer the humid air 16 and the dehumidified air 14 to and from the IC engine, may take other configurations, numbers and routing of tubes, and valves or connection joints to suit the particular application and performance requirements as understood by those skilled in the art.

In the above described examples of alternate configurations of the IC engine 12 and system 10, it is understood that the dehumidified air 14 is transferred from the dehydrator 50 to the IC engine 12 through the air outlet tube 58 to the oil filler port 22 and the exhaust pipe 42 in the manner(s) described, the dehumidified air 14 is circulated through the IC engine 12 under forced air flow and/or air pressure created by the at least one fan 119, and the humid air 16 from the IC engine 12 is returned to the dehydrator 50 through the oil breather pipe 46 and through the air inlet tube 54 in the manner(s) described.

As the described air transfer tubes and fittings in communication with the dehydrator 50 and the IC engine 12 are sealed connections, and the air provided to the dehydrator 50 (i.e., the humid air 16) is received from the interior of the IC engine 12, the described examples of system 10 form a sealed dehumidification system in which ambient air (i.e., the environmental air in the relative immediate surroundings of the dehydrator 50) is prevented, or substantially prevented, from being drawn into the dehydrator 50. As described above, the system 10 is a sealed system and is also a closed loop system. As ambient air is not drawn into the dehydrator 50, the system 10 is much more effective and efficient at removing or reducing the humidity from the interior of the IC engine 12. As further described below, the system 10 is also much more effective and efficient at circulating dehumidified air 14 to all of the vital internal areas and internal components of IC engines 12 to reduce corrosion caused by humidity or moisture to the vital internal components of the IC engine 12.

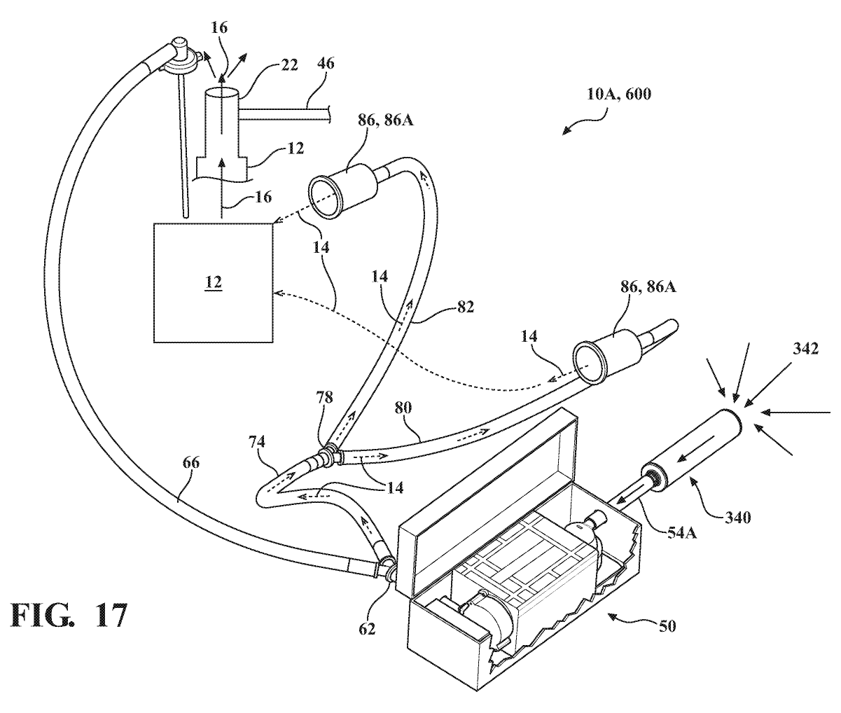

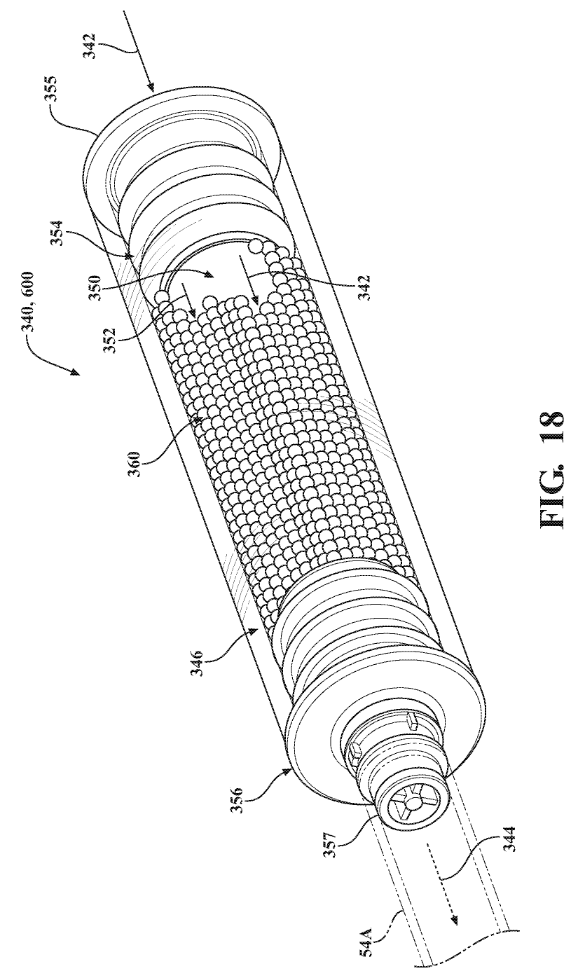

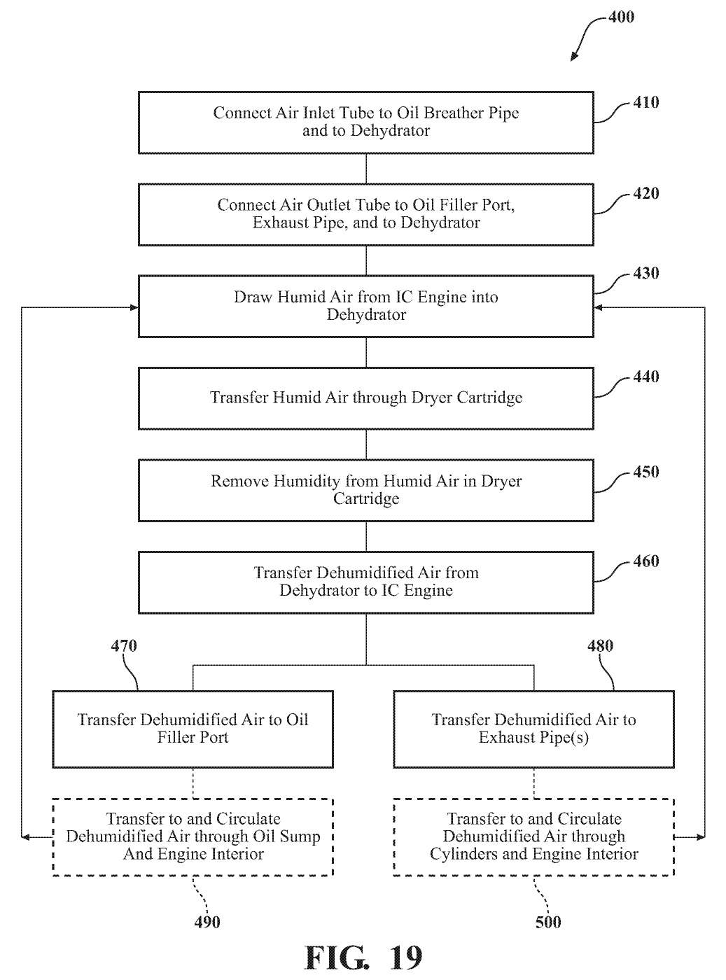

Referring to FIGS. 17 and 18, an alternate configuration and/or accessory for the system 10 is shown as system 10A. As described above and generally shown in the system 10 example configuration shown in FIGS. 1, 3 and 5, the system 10 includes the dehydrator 50, the air inlet tube 54, the air outlet tube 58, the first valve 62, the first air outlet tube 66, the oil filler fitting 70, the second air outlet tube 74, the second valve 78, the first exhaust outlet tube 80, the second exhaust outlet tube 82, the exhaust fitting 86, the oil breather pipe fitting 90, the clip 92, and the oil particulate filter 94 as generally described above. As described, these components can be, for example, provided in a kit or assembly which is then configured to be connected to the particular IC engine 12 in one or more of the manners described above.

In one example of the system 10 shown in the system 10A configuration as best seen in FIG. 17, the system 10A is configured to selectively connect to the IC engine 12 and operate a purge cycle, or purge cycles, described further below to initially circulate dehumidified air 14 inside the interior of the IC engine 12 without returning the humid air 16 from the IC engine 12 through the air inlet tube 54 back into the dehydrator 50. Referring to the FIG. 17 example and generally to FIG. 1, the dehydrator 50 is connected to the air outlet tube 58 that is connected to the first valve 62 as generally described above. The first air outlet tube 66 and the oil filler fitting 70 may remain connected to the first valve 62 (as shown) or may be disconnected from the first valve 62 (not shown) . In the example of the system 10A configuration in use in the purge cycle, the first valve 62 is manipulated or configured to close the passage of the dehumidified air 14 from entering into the first air outlet tube 66 so that no dehumidified air 14 is transferred to the oil filler port 22. The first valve 62 is configured to open or allow the dehumidified air 14 to flow through the second air outlet tube 74 to the exhaust fitting 86 (two shown) to transfer the dehumidified air 14 through the exhaust pipe 42 and into the IC engine 12 as generally and highly schematically shown in FIG. 2 and described above and further below.

In the FIG. 17 example of the system 10A and the purge cycle, the oil filler fitting 70 is not installed or engaged with the oil filler port 22. In the example, a native or normally used oil filler cap (not shown) is removed allowing air within the IC engine 12 to be vented to and be in open communication with the environment surrounding the IC engine 12. In an example wherein the system 10 and the system 10A configuration is used with the IC engine 12 for an aircraft, the purge cycle is advantageous when the IC engine 12 has recently been in use (i.e., the aircraft has been recently flown) and placed in a condition at rest. In this condition, the IC engine 12 is hot and there is typically a high level of humidity in the interior of the IC engine 12. In order to initially purge the high level of humidity in the IC engine, it is useful to purge or blow out the high level of humidity without the humid air 16 being transferred to dehydrator 50 and the dryer media 176 which may cause premature or accelerated saturation of the dryer media 176 requiring frequent regeneration.

Referring to the FIGS. 17 and 18 example and the above described IC engine 12 in a hot condition and at rest, to prevent the humid air 16 from being transferred to the dehydrator 50, the air inlet tube 54 and oil breather pipe fitting 90 are not connected to the oil breather pipe 64 as shown in FIGS. 1 and 2. In the FIG. 17 example, a purge dryer filter 340 is positioned upstream of the air inlet 105 of the case 100 and in communication with an air purge inlet tube 54A. In one example, the air purge inlet tube 54A is the air inlet tube 54, a portion of the air inlet tube 54, or is a separate shorter air inlet tube as compared to the air inlet tube 54. In the example as best seen in FIG. 17, the air purge inlet tube 54A is sealingly connected to the air inlet 105 (FIG. 4) of the case 100 and is sealingly connected to the purge dryer filter 340 as generally shown in FIG. 17 and described further below. The at least one fan 119 is configured to draw ambient air 342 from the environment surrounding the dehydrator 50 and the purge dryer filter 340 through the purge dryer filter 340 and toward the dehydrator 50. Generally, the dehydrator 50 removes humidity (or moisture) from the ambient air 342 and exits dehumidified air 14 from the dehydrator 50 as described above. The dehumidified air 14 is transferred to and through the exhaust pipe 42 (or exhaust pipes 42) and into the interior of the IC engine 12 as described above and generally shown in FIG. 2. The dehumidified air 14 is circulated throughout the interior of the IC engine 12 and absorbs humidity changing to humid air 16 (generally and schematically shown as solid arrow heads) and exits the IC engine 12 through the oil filler port 22 to the environment as generally shown.

Referring to FIG. 18, an example of the purge dryer filter 340 is shown. In the example, the purge dryer filter 340 includes a housing 346 configured as a hollow, open ended cylinder defining a cavity 350 forming an air passage 352 through the cavity 350 as generally shown. In the example, an air inlet cap 354 having an air inlet end 355 is sealingly engaged with the housing 346 upstream of the cavity 350 of the housing 346. The air inlet cap 354 defines a through bore which places the cavity 350 in communication with the ambient air 342 in the environment. The air inlet end 355 may include a screen and/or filter (not shown) to filter the ambient air 342 to prevent undesirable air or debris particles from entering the cavity 350 of the purge dryer filter 340 and the dehydrator 50.

An air outlet cap 356 includes an air outlet end 357 and is sealingly engaged with the housing 346 at an opposing end of the housing 346 downstream of the cavity 350 of the housing 346 and is sealingly engaged with the air purge inlet tube 54A as generally shown in FIGS. 17 and 18. The air outlet cap 356 defines a through bore placing the cavity 350 in communication with the air purge inlet tube 54A.

In the FIG. 18 example, the cavity 350 is wholly or partially filled with filter dryer media 360 as generally shown. The filter dryer media 360 may be the same as the dryer media 176 used in the dryer cartridge 118 in the dehydrator 50 as described above. The filter dryer media 360 may be of a different form or type to remove humidity from the ambient air 342 as known by persons skilled in the art. In one example, at least one of the air inlet cap 354 or the air outlet cap 356 may be removable from the housing 346 so the filter dryer media 360 can be removed from the housing 346 and reactivated or regenerated as described for the dryer media 176. In one example, the housing 346 is transparent and the filter dryer media 360 is of the type that changes color as humidity is absorbed by the filter dryer media 360 providing a visual indication whether the filter dryer media 360 remains efficient at removing humidity or whether regeneration is needed. In one example (not shown) one or more sensors in communication with the controller 130 may be used to measure and monitor the humidity and other metrics described above to monitor a condition of the filter dryer media 360 for effectiveness of the filter dryer media 360 to remove humidity from the ambient air 342 as described above for the first sensor 122 and/or the second sensor 126 as described above.

As best seen in FIGS. 17 and 18, in operation when the purge cycle is initiated, the at least one fan 119 in the dehydrator 50 draws the ambient air 342 from the environment into the purge dryer filter 340 and through the air passage 352 in communication with the filter dryer media 360 which removes humidity from the ambient air 342 upstream of the dehydrator 50. Dehumidified ambient air 344 is transferred through the air outlet cap 356, through the air purge inlet tube 54A and into the dehydrator 50. Dehumidified air 14 exited from the dehydrator 50 is transferred to the exhaust pipe 42 and into the IC engine 12 to initially purge or blow out humid air 16 through the oil filler port 22 and into the environment as generally shown in FIG. 17 and described above. It is understood that the purge dryer filter 340 may take other configurations, shapes, forms, dimensions and components as known by persons skilled in the art.

In an alternate example of system 10A (not shown) used for the purge of humid air 16 from the IC engine 12 recently placed at rest, the system 10 as shown and described in FIGS. 1-3 may be used for the purge cycle. In the example, the oil filler fitting 70 may be used and engaged with the oil filler port 22 as described above. In the example, the purge dryer filter 340 is removably installed in the air inlet tube 54 downstream of the oil particulate filter 94 and upstream of the dehydrator 50. In the example, for the purge cycle, the first valve 62 is configured to allow dehumidified air 14 to be transferred to both the oil filler port 22 and the exhaust pipe 42 as described above for FIGS. 1-3. The air inlet tube 54 and the oil breather pipe fitting 90 are connected to the oil breather pipe 46 as described above. On activation of the dehydrator 50, humid air 16 is drawn from the IC engine 12 into the dehydrator 50 and dehumidified air 14 is transferred to the IC engine 12 as described for FIGS. 1-5. In one example, once the initial purge cycle is completed, the purge dryer filter 340 can be removed from air inlet tube 54 leaving the oil particulate filter 94 connected to and in communication with the air inlet tube 54, thereby reconfiguring the system 10A to the system 10 shown in FIGS. 1-3 for operation as described above.

In the above example wherein the oil filter fitting 70 is used and humid air 16 is returned to the dehydrator 50 in an initial purge cycle (not shown), the use of the both of the oil particulate filter 94 to filter out oil vapor 270 upstream of the purge dryer filter 340 prevents the filter dryer media 360 from being contaminated with oil particulate from the IC engine 12 as described above, and the purge dryer filter 340 serves to at least partially remove a high level of humidity from the humid air 16 received from the IC engine 12 thereby assisting in increasing the longevity of the dryer media 176 in the dehydrator 50.

In an alternate example of the configuration of system 10A for a purge cycle (not shown), the purge dryer filter 340 may be configured to include both of the oil particulate filter 94 (e.g., see FIGS. 14 and 1) upstream of filter dryer media 360 to sequentially filter oil vapor 270 and humidity from the humid air 16 drawn from the IC engine 12 and upstream of the dehydrator 50. It is understood that the system 10A may take alternate configurations, components, and locations of the components relative to the IC engine 12 and the dehydrator 50 as known by persons skilled in the art.

Referring to FIG. 19, an example of a method 400 of dehumidifying an interior of an internal combustion engine, IC engine 12, is shown. In one example, the IC engine 12 is an aircraft engine configured as shown in FIGS. 1 and 2 and described above. It is understood that the IC engine 12 may take other configurations and have other applications, for example, automotive or industrial equipment engines, as described above. In the example method, the method 400 may be used with the system 10 as described in FIGS. 1-3 and alternate configurations of system 10 described above (e.g., system 10A in FIG. 17). It is understood that alternate configurations of the system 10 may be used with the method 400.

In an example first step 410, the method includes sealingly connecting the air inlet tube 54 to the oil breather pipe 46 of the IC engine 12 and to the air inlet 105 of the dehydrator 50. In one example, the oil breather pipe fitting 90 as described above is sealingly connected to the air inlet tube 54 and then the oil breather pipe fitting 90 and the connected air inlet tube 54 are sealingly engaged with the oil breather pipe 46 as described above.

In an alternate first step (not shown), the dryer media 176 is installed in the cavity 166 of the dryer cartridge 118. In one example, the cover 158 of the dryer cartridge 118 is moved relative to the frame 154 to allow the dryer media 176 to be installed in the cavity 166 as described above and shown in FIG. 6. In another step (not shown) the dryer cartridge 118 with the installed dryer media 176 is installed as a single unit (e.g., FIG. 6) in the housing 102 of the dehydrator 50 as described above and best seen in FIG. 4.

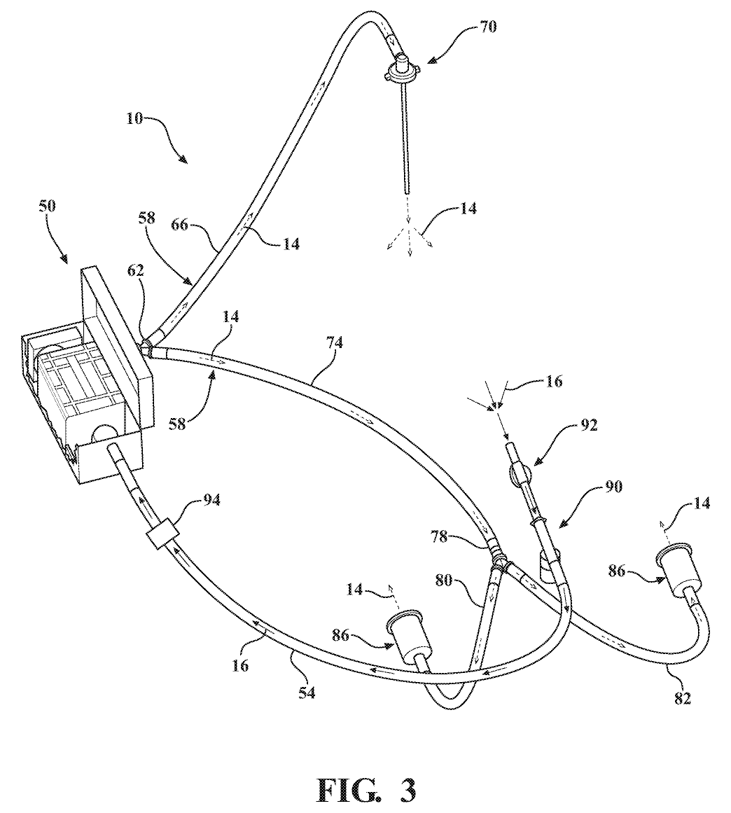

Example step 420 includes sealingly connecting the air outlet tube 58 to the oil filler port 22 of the IC engine 12, to the exhaust pipe 42 of the IC engine 12, and to the air outlet 106 of the dehydrator 50. In one example, the oil filler fitting 70 as described above is sealingly connected to the air outlet tube 58, or the first air outlet tube 66, and then the oil filler fitting 70 and the connected first air outlet tube 66 are sealingly connected to the oil filler port 22. In another example, the exhaust fitting 86 as described above is sealingly connected to the second air outlet tube 74, or the first exhaust outlet tube 80 or the second exhaust outlet tube 82, and then the exhaust fitting 86 and the connected air outlet tube are sealingly engaged with the exhaust pipe 42 as described above. In one example of system 10, and in a common method of use and operation of system 10, the oil breather pipe fitting 90 is preconnected to the air inlet tube 54 and the air inlet tube is preconnected to the air inlet 105 of the dehydrator 50. Equally, the oil filler fitting 70 and the exhaust fitting 86 are preconnected to the air outlet tube 58 and the dehydrator 50 (i.e., the system 10 is preassembled as a kit (see e.g., FIG. 3)) and the described fittings simply need to be sealingly connected to the IC engine 12 in the manners described above, and the system 10 connected with a power source in the manners described herein. Alternately, the dehydrator 50, the air inlet tube 54, the air outlet tube 58, the oil breather pipe fitting 90, the oil filler fitting 70, and the exhaust fitting 86, can be provided as a kit unassembled and then configured and assembled by a user to suit the particular IC engine 12.

Example step 430 includes forcibly drawing humid air 16 by the at least one fan 119 connected to the dehydrator 50 from the interior of the IC engine 12 through the air inlet tube 54 into an interior 108 of the dehydrator 50 preventing, or substantially preventing,, ambient air from an environment immediately surrounding the dehydrator 50 from entering the dehydrator. In one example, the at least one fan 119 includes the first fan 120 and the second fan 124 as described above and best seen in the FIG. 4 example.

Example step 440 includes transferring by the at least one fan 119 the humid air 16 along an air pathway 109 in the dehydrator 50 through the dryer cartridge 118. In one example, the dryer cartridge 118 includes the dryer media 176 and is selectively removable from the dehydrator 50 as a single unit for reactivation of the dryer media 176 while the dryer media 176 remains in the dryer cartridge 118 as described above and best seen in the FIG. 6 example.

Example step 450 includes removing humidity from the humid air 16 passing through the dryer cartridge 118 and exiting dehumidified air 14 under the force of the at least one fan 119 along the air pathway 109 through the air outlet 106 of the dehydrator 50. In one example described above, the dryer media 176 in the dryer cartridge 118 is desiccant.

Example step 460 includes transferring by the at least one fan 119 the dehumidified air 14 through the air outlet tube 58 to the interior of the IC engine 12. In one example step 470, the dehumidified air 14 is transferred though a first valve 62 and the first air outlet tube 66 through the oil filler port 22. In one example, the oil filler fitting 70 described above is sealingly connected to the air outlet tube 58, or the first air outlet tube 66, and the oil filler fitting 70 and connected first air outlet tube 66 is sealingly engaged with the oil filler port 22 as described above. In one example, the oil filler fitting 70 includes the elongate down tube 196 that directs the dehumidified air 14 toward the oil sump 24 and has a second end 202 positioned in proximity to the reservoir oil level 25 as described above. In another example, the oil filler fitting 70 includes the constrictor 208 which increases the velocity of the air flow of the dehumidified air 14 as described above.

In one example step 480, the dehumidified air 14 is simultaneously transferred through the first valve 62 and the second air outlet tube 74 through the exhaust pipe 42. In one example, the exhaust fitting 86 described above is sealingly connected to the air outlet tube 58, or the second air outlet tube 74, and the exhaust fitting 86, and the connected air outlet tube 58 or the second air outlet tube 74 is sealingly engaged with the exhaust pipe 42 as described above. In one example where the IC engine 12 includes two exhaust pipes, the second air outlet tube 74 includes the second valve 78 and the first exhaust outlet tube 80 and the second exhaust outlet tube 82, and exhaust fittings 86, respectively, as described above. In one example, the exhaust fitting 86 includes the constrictor 232 to increase the velocity of the flow of the dehumidified air 14 through the exhaust pipe 42 as described above.

In example step 490, the method 400 includes transferring the dehumidified air 14 to the oil sump 24, circulating the dehumidified air 14 in and around the oil sump 24, and then throughout the interior of the IC engine 12. As described in the example above and as best seen in FIGS. 1 and 8, the oil filler fitting 70 includes the elongate down tube 196 which includes the second end 202 in the oil sump 24 in proximity to the reservoir oil level 25. In one example of transferring the dehumidified air 14 to the interior of the IC engine 12, the dehumidified air 14 is transferred directly to the oil sump 24 of the IC engine 12 as described above and best seen in FIG. 1.

By exiting the dehumidified air 14 through the oil filler port 22 and directly into the oil sump 24, the dehumidified air 14 is directly circulated into and about the oil sump 24 which is where a relatively high amount of humidity exists due to the reservoir of oil in the IC engine 12. This is particularly the circumstance when, for example, an aircraft engine is run and then placed at rest (i.e., stopped from running and stored). By directing the dehumidified air 14 directly into the oil sump 24, humidity is more effectively and more efficiently removed from the interior of the IC engine 12 and the important components, for example the camshaft 28 and other internal components located in this part of the IC engine 12 that are susceptible to corrosion due to humidity or moisture, are more effectively treated and protected. As schematically illustrated in FIGS. 1 and 2, the dehumidified air 14, now humid air 16 after having absorbed humidity from the interior of the IC engine, propagates under air pressure and/or forced air flow from the at least one fan 119 toward other interior areas of the IC engine 12 and toward the oil breather pipe 46 for return of the humid air 16 back to the dehydrator 50.

As best seen in FIG. 1, in one advantageous aspect of system 10 and configuration of the oil filler fitting 70 as described when the IC engine 12 is hot, forcing and exiting the dehumidified air 14 directly to the oil sump 24 through the elongate down tube 196 and proximate to the reservoir oil level 25 as described above, assists in the natural rising of hot air inside the IC engine 12 upward toward the upper area of the IC engine 12 and toward the oil breather pipe 46. Once the dehumidified air 14 (now with at least some additional absorbed humidity from the oil sump 24 and other lower areas of the IC engine 12), the dehumidified air 14 propagates to and through the upper parts of the IC engine 12 including in and around the cylinders 20 (and absorbing more humidity in these areas of the IC engine 12) removing humidity from those parts of the IC engine 12 (see FIG. 2). In one example of use of the system 10 on an IC engine that has been at rest or has been allowed to cool, the dimensional contraction of the internal engine components, for example the cylinders 20 and the pistons 30, increases the spatial gaps between these components allowing for the dehumidified air 14 to pass through, by the forced air flow and/or air pressure by the at least one fan 119, and remove humidity that has remained in these areas of the IC engine 12.

In example step 500 and as best seen in the FIG. 2 example, the method 400 includes also simultaneously transferring the dehumidified air 14 up through the exhaust pipe 42, through the exhaust manifold 38 (two shown in FIG. 2), through the cylinder block 18 to the cylinders 20 of the IC engine 12. In the example of the IC engine 12, each cylinder 20 includes the intake valve 34 and the exhaust valve 36. As known by persons skilled in the art, when a running IC engine 12 stops, one or more of the exhaust valves 36 will remain open (as shown in FIG. 2, all exhaust valves 36 shown open for ease of illustration only) thereby placing the cylinder 20 having the exhaust valve 36 that is open in air flow communication with the exhaust manifold 38 and the exhaust pipe 42 corresponding thereto. In one example of transferring the dehumidified air 14 to the interior of the IC engine 12, the dehumidified air 14 is transferred directly to the cylinders 20 of the IC engine 12 as described above and best seen in FIG. 2.

By transferring dehumidified air 14 through the exhaust pipe 42 as described, the dehumidified air 14 is transferred directly into cylinders 20 having an exhaust valve 36 that is open and providing for circulation of the dehumidified air 14 to at least the cylinders 20 having the exhaust valve 36 that is open. This provides for more effective and efficient circulation of dehumidified air 14 to the cylinders 20, pistons 30, and other important components in that area of the IC engine 12 that are susceptible to corrosion due to humidity. As the IC engine 12 is used in the future and then placed at rest, alternate cylinders are likely to have the exhaust valve 36 open so on use of the system 10, those alternate cylinders will be circulated with dehumidified air 14. In one example wherein the IC engine 12 is an aircraft engine at rest, the propeller can be manually rotated which will open alternate of the exhaust valves 36 allowing circulation of the dehumidified air 14 through those alternate cylinders 20. In one example, the system 10 can be activated for a run cycle 730, stopped, the propeller manually rotated to open alternate of the exhaust valves 36, and a second run cycle of the system 10 can be initiated. In one advantageous aspect of the system 10, for example when the IC engine 12 is cool or has been at rest, the dehumidified air 14 circulates in and around the cylinders 20 as described and also propagates to other areas of the IC engine 12 (e.g., in and around the oil sump 24 to mix with the dehumidified air received through the oil filler fitting 70 as described).

As schematically illustrated in FIGS. 1 and 2, the dehumidified air 14, now humid air 16 after having absorbed humidity from the interior of the IC engine 12 in and around the cylinders 20, propagates under air pressure from the at least one fan 119 toward other interior areas of the IC engine 12 and eventually toward the oil breather pipe 46 for return of the humid air 16 back to the dehydrator 50 in a sealed and also closed loop engine dehumidification system.

In one example method step (not illustrated in FIG. 19), the method 400 includes measuring by the first sensor 122 positioned upstream of the dryer cartridge 118 at least one of humidity (e.g., relative humidity), temperature, air pressure, fan speed of the at least one fan 119, or energy consumption by the at least one fan 119, as described above. The example includes measuring by the second sensor 126 positioned downstream of the dryer cartridge 118 at least one of humidity (e.g., relative humidity), temperature, air pressure, a fan speed of the at least one fan 119, or energy consumption by the at least one fan 119, as described above. The method includes comparing by the controller 130 in communication with the first sensor 122, the second sensor 126, and the at least one fan 119, signals received respectively from the first sensor 122 and the second sensor 126 to predetermined values. The method includes adjusting operation of the dehydrator 50 based on the signals respectively received as disclosed above.

In one example of the immediately above example, the first sensor 122 includes a first humidity sensor 122A configured to measure the humidity of the humid air 16 from the interior of the IC engine and the second sensor 126 includes a second humidity sensor 126A configured to measure the humidity of the dehumidified air 14 received from the dryer cartridge 118. In one example, the step of adjusting the operation of the dehydrator 50 includes at least one of energizing, deenergizing, increasing the fan speed, or decreasing the fan speed of the at least one fan 119 based on the humidity as measured by at least one of the first humidity sensor 122A or the second humidity sensor 126A as described above.

In one example of the immediately above example, the method includes comparing by the controller 130 the humidity as measured by the first humidity sensor 122A to the humidity as measured by the second humidity sensor 126A and calculating the differential humidity 139 to monitor an effectiveness of the dryer media 176 in removing the humidity from the humid air 16 received from the interior of the IC engine. The example method step includes deenergizing the at least one fan 119 by the controller 130 when the differential humidity 139 falls below a predetermined value indicative of a condition that the dryer media 176 is saturated and in need of reactivation (e.g., removal of moisture absorbed by the dryer media 176) or replacement.

As described in one or more of the examples of the method 400 and the system 10, 10A above in measuring humidity above, the method 400 may measure the humidity (e.g., relative humidity) of the humid air 16 upstream of the dryer cartridge 118 by the first sensor 122 as described above. In another example, the temperature of the humid air 16 upstream of the dryer cartridge 118 may also be measured as described above. In another example, the humidity of the dehumidified air 14 is measured downstream of the dryer cartridge 118 by the second sensor 126 as described above. In another example, the temperature of the dehumidified air 14 is measured downstream of the dryer cartridge 118 as described above. As described above, additional of the metrics described above may be measured by sensors. In one example, the measured humidity, temperature and/or other of the metrics measured are processed and analyzed by the controller 130 and displayed on a display panel 134 as described above.

In one example method step (not shown), the controller 130 controls and actives the at least one fan 119 to begin operation of the dehydrator 50 and system 10 according to preprogrammed and stored instructions based on the measured humidity in the humid air 16 and/or the other metrics. The method 400 and/or system 10 operate and serve to remove from, or actively monitor and maintain, a level of humidity in the interior of the IC engine 12 to prevent, reduce, or significantly inhibit, corrosion of the interior components of the IC engine 12 due to retained moisture in the interior when the IC engine 12 is at rest, in the manners described herein. Alternately, a user may manually activate and deactivate the operation of the system 10.

In one method step (not illustrated in FIG. 19), the method 400 includes installing or securing the clip 92 to selectively cover and seal the ice hole aperture 306 in the oil breather pipe 46 that is common in IC engines 12 for aircraft. Installation of the clip 92 prevents the humid air 16 from passing through the ice hole aperture when the system 10 is in operation to circulate the dehumidified air 14 through the IC engine 12 as described above.

It is understood that method 400 may include additional steps, alternate steps, or a different order or sequence of steps, as described above and applicable to the systems 10, 10A as described above, and to suit the particular application and performance specification as known be persons skilled in the art.

In the method 400 and system 10 examples, the combination of transferring the dehumidified air 14 through the oil filler port 22 directly to the oil sump 24 and through the exhaust pipe 42 directly to the cylinders 20 is advantageous and a much more effective and more efficient dehumidification system over prior devices and methods. Further, the method 400 and the system 10 forms a sealed, or substantially sealed, system which prevents the ambient air, and the present environmental humidity therein, from being drawn into the dehydrator 50. As described, the system 10 is also configured as a closed loop system.

In a particularly advantageous application on aircraft engines, by only drawing the humid air 16 from the interior of the IC engine 12, and not from the environmental air immediately surrounding the dehydrator 50, the system 10 and dehydrator 50 are much more effective and much more efficient in removing humidity and drying the air in the interior of the IC engine 12 and extends the duration of the absorption capacity of the dryer media 176 in the dryer cartridge 118. By extending the duration and absorption capacity of the dryer media 176, the system 10 is capable of and is configured to be a system for continuous and long term system to monitor the humidity level of the IC engine 12 at rest, maintain a desired humidity level in the interior of the IC engine 12 (e.g., below 20 percent relative humidity) at rest, and serve as a preservation system for the interior of the IC engine and vital internal engine components preventing, or significantly inhibiting, corrosion due to remaining moisture inside the engine while the engine remains at rest.

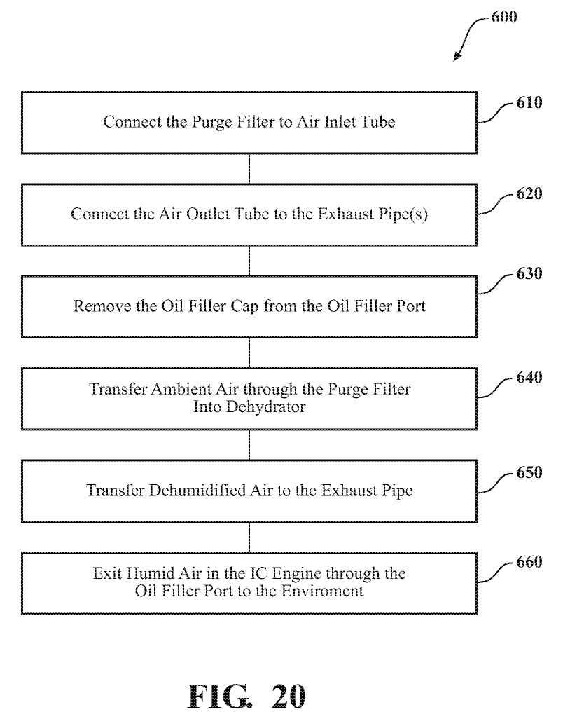

Referring to FIG. 20, a flow chart of one example of a method 600 for purging humidity from an IC engine 12 during a purge cycle using the system 10 configured as the system 10A is shown. In the example, the system 10 is configured as the system 10A shown in FIGS. 17 and 18 as described above.

In an example step 610, a purge dryer filter 340 is sealingly connected to the air inlet tube 54 upstream of the dehydrator 50. The air inlet tube 54 is sealingly connected to the air inlet 105 of the dehydrator 50 as described above and as best seen in FIG. 4.

In an example step 620, the second air outlet tube 74 and the connected exhaust fitting 86, 86A are sealingly connected to the exhaust pipe 42 as generally described above and illustrated. In one example shown in FIGS. 1 and 2, where the IC engine 12 includes two exhaust pipes, the first exhaust outlet tube 80 and the second exhaust outlet tube 82, and the respective exhaust fitting 86, are respectively sealingly connected to the respective exhaust pipe 42.

In example step 630, a native or normally used oil filler cap (not shown) is disengaged and removed from the oil filler port 22 placing air in the interior of the IC engine 12 in communication with the environment surrounding the IC engine 12. In the example shown in FIG. 17, the first valve 62 is manipulated or configured to close off the first air outlet tube 66 preventing dehumidified air 14 from being transferred to the oil filler port 22 and allowing the dehumidified air 14 to transfer to the exhaust pipe 46 as described above.

In example step 630, ambient air 342 is transferred through the purge dryer filter 340 from the environment wherein humidity is removed from the ambient air 342 upstream of the dehydrator 50. In one example, the at least one fan 119 of the dehydrator 50 is activated or energized by the controller 130 to draw in the ambient air 342 from the environment into and through the purge dryer filter 340 as described above and best seen in FIG. 18.

In example step 650, dehumidified air 14 is transferred to the exhaust pipe 46 through the first valve 62, the second air outlet tube 74, and the exhaust fitting 86, 86A as described above (e.g., as schematically shown in FIG. 2 by the dehumidified air 14 passing through the exhaust pipes 42, the exhaust manifolds 38 and into the interior of the IC engine 12). As described above and schematically illustrated in FIGS. 17, 2 and 1, the dehumidified air 14 circulates through the interior of the IC engine 12 to absorb humidity (or moisture) in the interior of the IC engine 12 changing the dehumidified air 14 to humid air 16 as described above. In the example as shown in FIG. 17, as the air inlet tube 54 is not connected to the oil breather pipe 46, the humid air 16 is not returned to the dehydrator 50 as described above for system 10 (i.e., as shown and described for FIGS. 1-3).

In example step 660 and shown in FIG. 17, humid air 16 is exited or forced out of the IC engine 12 through the oil filler port 22 which is open to the environment. Through use of the purge cycle and method 600, high humidity air in the interior of the IC engine 12 is exited to the environment rather than being transferred to the dehydrator 50 which is advantageous to increasing the longevity of the dryer media 176 in the dehydrator 50 reducing the need to regenerate the dryer media 176.

In one example, the purge cycle and the method 600 are only used promptly following the IC engine 12 having been in use (e.g., IC engine 12 is an aircraft engine) and recently placed in a rest condition (i.e., IC engine 12 is shut off or is stopped from running). In one example, the purge cycle as generally shown and described as system 10A and method 600 are used for a relatively short and predetermined period of time promptly following the IC engine 12 placed in a condition of rest. In one example, the purge cycle, i.e., system 10 is manipulated to the configuration of the system 10A in FIGS. 17 and 18, and the at least one fan 119 is energized for a predetermined period of time to purge or blow out the high humidity air from the IC engine 12 through the oil filler port 22 as described above. In one example, the controller 130 is preprogrammed with a purge cycle as described and the predetermined time for the purge cycle is for the at least one fan 119 to run or be energized for four (4) minutes. It is understood that different predetermined times for the purge cycle, higher or lower, and in incremental amounts, can be used to suit the particular application and environmental conditions as known by persons skilled in the art.

In one example where the purge cycle is a preprogrammed cycle or mode in the controller 130, a user can select the purge cycle from an option presented by the GUI of the display panel 134, as an example. In an alternate example, a user can configure the system 10 as described and shown in FIG. 17, and manually activate the system 10 and/or energize the at least one fan 119 as generally described in the above examples for system 10.

In one example following the purge cycle and method 600, the system 10A can then be manipulated or configured to the system 10 in the form of the sealed and closed loop system shown in FIGS. 1-5 for normal operation to remove humidity from the IC engine 12 as described above. In one example, the purge dryer filter 340 is replaced by the oil particulate filter 94.

In an alternate example, the method 600 may include one or more, for example two (2), purge cycles run sequentially at a predetermined time apart to further remove high humidity from the IC engine 12 following use and then placed in a condition of rest. In one example of method 600, the purge cycle may be run as described, then the system 10A is configured back to the system 10 (i.e., FIGS. 1-5) and the start up mode as described above may be run (e.g. a short run time for system 10 in order to measure the humidity of the humid air 16 received from the IC engine 12 by the first sensor 122 as described above). If a high relative humidity is measured from the humid air 16 received from the IC engine 12, the system 10 can be manipulated and reconfigured to the system 10A and another purge cycle may be run. This process may be repeated until the humidity in the humid air 16 is reduced and normal operation in the system 10 configuration can be maintained and dehumidifying cycles run as described above in the system 10 configuration.

It is understood that method 600 can include additional steps, the elimination of steps, or a different order of steps as described without deviating from the present invention.

In one example (not shown), method 400 may include as a first step (e.g., as a step 405 in FIG. 19) the method 600 wherein the system 10 is configured as the system 10A described above. In one example, on completion of the purge cycle and the method 400 as described, the purge dryer filter 340 is disconnected from the air inlet tube 54, and in one example, the oil particulate filter 94 is sealingly connected to the air inlet tube 54 as described above thereby restoring or reconfiguring the system in the configuration as the system 10. Then, the method 400 as described may be initiated in the form of the sealed dehumidification system 10 as described above.

Referring generally to FIGS. 3, 4 and 5, an alternate example of the invention includes the use of the dehydrator 50 to remove humidity from an enclosure device or object that is not an IC engine 12. In one example, the dehydrator 50 is used to remove humidity from the air inside a substantially air tight device, for example a gun safe or other safe or vault, a camera equipment storage cabinet, or other enclosure device, cabinet or object used for storing sensitive devices, equipment, articles, and/or objects, where it is desired to control the amount of humidity in the air inside the substantially air tight device, or other enclosure device.

In one example of the alternate invention, the dehydrator 50 as described above is sealingly connected with an air inlet tube 54 that is sealingly connected with the enclosure device in communication with an interior of the enclosure device having a cavity with air. The dehydrator 50 as described above is also used with an air outlet tube 58 that is sealingly connected with the enclosure device in communication with the interior of the cavity of the enclosure device. Alternate fittings (not shown) may be used to connect the air inlet tube 54 and the air outlet tube 58 to corresponding respective inlet and outlet fittings of the enclosure device.

The dehydrator 50 includes the at least one fan 119 and the dryer cartridge 118 to draw humid air (e.g. humid air16 as generally described for an engine application) from the interior of the enclosure device, dry the humid air 16 in the dryer cartridge 118, and provide dehumidified air (e.g., dehumidified air14 as generally described for an engine application) to the interior of the enclosure device to remove humidity from the interior of the enclosure device as generally described herein for dehydrator 50. In one example, the dehydrator 50 may include a controller 130, at least one sensor in communication with the controller 130 to measure at least one of the metrics described above for system 10 (e.g., humidity and/or temperature), and a display panel 134 as described above. The controller 130 may adjust the operation of the dehydrator 50 based on the measurements by the sensor as described above for system 10.

It is understood the dehydrator 50, the air inlet tube 54, and the air outlet tube 58, may take alternate configurations, features and/or functions to suit the particular application (i.e., the configuration of the enclosure device) as known by persons skilled in the art. It is understood in this example invention that the dehydrator 50 may include or not use one or more of the components and functions as described for system 10 above for use with IC engine 12.

It is understood that system 10 and method 400 may use one or more of the above described and/or illustrated components or steps, or any individual combination thereof, without requiring one or more of the above described components or method steps. In other words, any of the described and/or illustrated individual components of the system 10 may be used with any other of the described and/or illustrated individual components of the system 10 without requiring other described and/or illustrated components of system 10.

In another example of the system 10 as best seen in FIG. 6, the dryer cartridge 118 further includes a frame 154; a plurality of sidewalls 156 connected to the frame 154 and defining a cavity 166, wherein at least two sidewalls of the plurality of sidewalls 156 are oriented transverse to the air pathway 109 in the case 100 and are configured to allow the humid air 16 and the dehumidified air 14 to pass through respective of the at least two sidewalls; and a cover 158 connected to the frame 154 and movable relative to the plurality of sidewalls 156, wherein the dryer media 176 is positioned in the cavity 166, the dryer media 176 configured to remove the humidity from the humid air 16 forced through the dryer cartridge 118 by the at least one fan 119 (e.g. the first fan 120 and the second fan 124).

In one example of the system 10 and method 400, wherein the system is configured as system 10A shown in FIG. 17, a purge dryer filter 340 is positioned upstream of the air inlet 105 of the case in communication with an air purge inlet tube 54A, the purge dryer filter 340 including a housing 346 defining a cavity 350 forming an air passage 352 through the cavity 350; an air inlet cap 354 having an air inlet end 355 is sealingly engaged to the housing 346 upstream of the cavity 350 of the housing; an air outlet cap 356 having an air outlet end 357 is sealingly engaged to the housing 346 at an opposing end of the housing 346 downstream of the cavity 350 of the housing 346, the air outlet cap 356 is sealingly engaged to an air purge inlet tube 54A, the air outlet end 357 defining a through bore placing the cavity 350 of the housing 346 in communication with the air purge inlet tube 54A; and a filter dryer media 360 is positioned in the cavity 350 of the housing 346, wherein the at least one fan 119 is configured to draw ambient air 342 from the environment into the purge dryer filter 340 and through the air passage 352 of the housing 346 in communication with the filter dryer media 360, wherein the filter dryer media 360 removes humidity from the ambient air 342 upstream of the dehydrator 50 and dehumidified ambient air 344 is transferred through the air purge inlet tube 54A into the dehydrator 50.

In one example of the system 10, the dryer media 176 comprises desiccant.

In one example of the system 10, the system 10 comprising: an oil filler fitting 70 comprising: a base 190 configured to sealingly connect to an oil filler port 22 of the IC engine 12; an inlet 194 connected to the base 190, the inlet is configured to sealingly connect to the air outlet tube 58; and an elongate down tube 196 having a first end 198 engaged with the base 190 in communication with the inlet and a second end 202 positioned proximate a reservoir oil level 25 in an oil sump 24 of the IC engine 12 configured to transfer the dehumidified air 14 to the oil sump of the IC engine; an air pressure sensor 122C connected to the elongate down tube 196 and configured to measure an air pressure in the interior of the IC engine 12; a controller 130 in communication with the air pressure sensor 122C and the at least one fan 119, wherein the controller 130 is configured to adjust the fan speed of the at least one fan 119 based on the air pressure as measured by the air pressure sensor 122C to maintain a positive air pressure in the interior of the IC engine 12.

In one example of the method 400, the first sensor 122 comprises a first temperature sensor configured to measure a temperature of the humid air 16 received from the interior of the IC engine 12 and the second sensor 126 comprises a second temperature sensor configured to measure the temperature of the dehumidified air 14 received from the dryer cartridge 118, wherein adjusting the operation of the sealed dehumidification system 10 comprises at least one of energizing, deenergizing, increasing the fan speed, or decreasing the fan speed of the at least one fan 119 (e.g., the first fan 120 and the second fan 124) based on the temperature as measured by at least one of the first temperature sensor or the second temperature sensor.

In one example of the method 400, wherein the first sensor 122 comprises a first airflow sensor configured to measure an airflow of the humid air 16 received from the interior of the IC engine 12 and the second sensor 126 comprises a second airflow sensor configured to measure the airflow of the dehumidified air 14 received from the dryer cartridge 118, wherein adjusting the operation of the sealed dehumidification system 10 comprises at least one of energizing, deenergizing, increasing the fan speed, or decreasing the fan speed of the at least one fan 119 (e.g., the first fan 120 and the second fan 124) based on the airflow as measured by at least one of the first airflow sensor or the second airflow sensor.

In one example of the method 400, wherein the first sensor 122 comprises a first air pressure sensor configured to measure an air pressure of the humid air 16 received from the interior of the IC engine 12 and the second sensor 126 comprises a second air pressure sensor configured to measure the air pressure of the dehumidified air 14 received from the dryer cartridge 118, wherein adjusting the operation of the sealed dehumidification system 10 comprises at least one of energizing, deenergizing, increasing the fan speed, or decreasing the fan speed of the at least one fan 119 (e.g., the first fan 120 and the second fan 124) based on the air pressure as measured by at least one of the first air pressure sensor or the second air pressure sensor.

In one example of the method 400, wherein the at least one fan 119 comprises a first fan 120 positioned upstream of the dryer cartridge 118 and a second fan 124 positioned downstream of the cartridge 118, wherein first sensor 122 comprises a first fan speed sensor configured to measure the fan speed of the first fan 120 and the second sensor comprises a second fan speed sensor configured to measure the fan speed of the second fan 124, wherein adjusting the operation of the sealed dehumidification system 10 comprises at least one of energizing, deenergizing, increasing the fan speed, or decreasing the fan speed of the first fan 120 and the second fan 124 based a measurement by a third sensor of at least one of the humidity, the temperature, the airflow, the air pressure, or the energy consumption of at least one of the first fan 120 or the second fan 124.

In one example of the method 400, wherein the at least one fan 119 comprises a first fan 120 positioned upstream of the dryer cartridge 118 and a second fan 124 positioned downstream of the dryer cartridge 118 wherein the first sensor 122 comprises a first fan energy consumption sensor configured to measure energy consumption of the first fan 120 in operation and the second sensor126 comprises a second fan energy consumption sensor configured to measure energy consumption of the second fan 124 in operation, wherein adjusting the operation of the sealed dehumidification system 10 comprises deenergizing at least one of the first fan 120 or the second fan 124 when the energy consumption as measured for the first fan 120 or the second fan 124 rises above a predetermined value.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A sealed dehumidification system for removing humidity from an interior of an internal combustion engine (IC engine) at rest, the system comprising:
a dehydrator comprising:
a case defining an interior, the case having an air inlet and an air outlet defining an air pathway through the interior of the case between the air inlet and the air outlet;
a dryer cartridge positioned in the interior of the case in communication with the air pathway configured to remove the humidity from humid air in the air pathway; and
at least one fan having a fan speed in communication with the air pathway;
an air inlet tube configured to sealingly connect to an oil breather pipe of the IC engine and to sealingly connect to the air inlet of the case; and
an air outlet tube configured to sealingly connect to the air outlet of the case and to sealingly connect to an oil filler port and an exhaust pipe of the IC engine, wherein the at least one fan is configured to draw the humid air from the interior of the IC engine through the oil breather pipe, through the air inlet tube, through the air inlet of the case, into the air pathway in the interior of the case and through the dryer cartridge, and force dehumidified air received from the dryer cartridge through the air outlet of the case, through the air outlet tube, to the oil filler port and the exhaust pipe of the IC engine forming the sealed dehumidification system wherein ambient air is prevented from being drawn into the dehydrator from an environment surrounding the dehydrator.

2. The system of claim 1, wherein the case further comprises a housing, the housing comprising:
an outer wall defining the interior of the case;
a first wall positioned in the interior of the case and defining an aperture, the first wall is connected to the outer wall and positioned transverse to the air pathway; and
a second wall positioned in the interior of the case downstream of the first wall and defining an aperture, the second wall is connected to the outer wall and positioned transverse to the air pathway, wherein the first wall, the second wall and the outer wall define an interior cavity for receipt of the dryer cartridge, wherein the at least one fan forces the humid air along the air pathway through the aperture in the first wall, through the dryer cartridge, and the dehumidified air through the aperture in the second wall.

3. The system of claim 2, wherein the dryer cartridge comprising:
a plurality of sidewalls defining a cavity, wherein at least two sidewalls of the plurality of sidewalls are oriented transverse to the air pathway and are configured to allow the humid air and the dehumidified air to pass through respective of the at least two sidewalls; and
dryer media positioned in the cavity of the plurality of sidewalls, the dryer media configured to remove the humidity from the humid air forced through the dryer cartridge by the at least one fan.

4. The system of claim 3, wherein the plurality of sidewalls comprise a cover movable relative to the plurality of sidewalls, the cover configured to allow the dryer media to be removed from the dryer cartridge.

5. The system of claim 3, wherein the dryer cartridge is selectively removable as a single unit from the interior cavity defined by the first wall, the second wall, and the outer wall of the housing, in order for the dryer media to be reactivated while remaining in the dryer cartridge.

6. The system of claim 3, wherein the plurality of sidewalls comprise a mesh material configured to allow the humid air to pass through the plurality of sidewalls.

7. The system of claim 2, wherein the at least one fan comprises:
a first fan positioned in the interior of the case upstream of the first wall, the first fan in communication with the air inlet tube and is configured to force the humid air through the aperture in the first wall and through the dryer cartridge; and
a second fan positioned in the interior of the case downstream of the second wall, the second fan in communication with the air outlet tube and is configured to draw the humid air through the dryer cartridge and the aperture in the second wall, and force the dehumidified air through the air outlet tube.

8. The system of claim 1, comprising:
a first sensor positioned upstream of the dryer cartridge, the first sensor configured to measure metrics of the sealed dehumidification system comprising at least one of humidity, temperature, airflow, air pressure, the fan speed of the at least one fan, or energy consumption by the at least one fan;
a second sensor positioned downstream of the dryer cartridge, the second sensor configured to measure metrics of the sealed dehumidification system comprising at least one of humidity, temperature, airflow, air pressure, the fan speed of the at least one fan, or energy consumption by the at least one fan; and
a controller in communication with the first sensor, the second sensor, and the at least one fan, the controller configured to monitor signals respectively received from the first sensor and the second sensor, compare the signals respectively received to predetermined values, and adjust operation of the sealed dehumidification system based on the signals respectively received.

9. The system of claim 8,
wherein the first sensor is a first humidity sensor positioned upstream of the dryer cartridge, the first humidity sensor configured to measure a humidity of the humid air received from the interior of the IC engine,
wherein the controller is configured to energize, deenergize, increase the fan speed, or decrease the fan speed of the at least one fan based on the humidity as measured by the first humidity sensor.

10. The system of claim 9, wherein the second sensor is a second humidity sensor positioned downstream of the dryer cartridge, the second humidity sensor configured to measure a humidity of the dehumidified air received from the dryer cartridge, and
wherein the controller is configured to energize, deenergize, increase the fan speed, or decrease the fan speed based on the humidity as measured by the second humidity sensor.

11. The system of claim 10,
wherein the controller is configured to compare the humidity measured by the first humidity sensor to the humidity measured by the second humidity sensor and calculate a differential humidity to monitor an effectiveness of a dryer media positioned in the dehydrator in removing the humidity from the humid air received from the interior of the IC engine,
wherein the controller is configured to deenergize the at least one fan when the differential humidity falls below a predetermined value indicative of a condition that the dryer media is saturated.

12. The system of claim 11, comprising a display panel in communication with the controller configured to display the differential humidity as calculated by the controller.

13. The system of claim 10, wherein at least one of the first sensor or the second sensor is configured to measure the fan speed of the at least one fan,
wherein the controller is configured to energize or deenergize the at least one fan based on the humidity measured by at least one of the first humidity sensor or the second humidity sensor.

14. The system of claim 13, wherein the controller is configured to increase the fan speed or decrease the fan speed as measured of the at least one fan based on the humidity measured by the at least one of the first humidity sensor or the second humidity sensor.

15. The system of claim 10, wherein at least one of the first sensor or the second sensor is configured to measure a temperature of the humid air received from the interior of the IC engine or a temperature of the dehumidified air received from the dryer cartridge, respectively,
wherein the controller is configured to energize, deenergize, increase the fan speed, or decrease the fan speed, of the at least one fan based on the temperature as measured by the at least one of the first sensor or the second sensor.

16. The system of claim 1, comprising:
an oil filler fitting having an inlet configured to sealing connect to the air outlet tube and an elongate down tube having a first end in communication with the inlet and a second end, the oil filler fitting configured to sealingly connect to the oil filler port of the IC engine, wherein the second end of the elongate down tube is positioned proximate to a reservoir oil level in an oil sump of the IC engine for transferring the dehumidified air to the oil sump of the IC engine;
an exhaust fitting having an inlet configured to sealing connect to the air outlet tube, the exhaust fitting configured to sealing connect to the exhaust pipe of the IC engine for transferring the dehumidified air to cylinders of the IC engine; and
an oil breather pipe fitting including an inlet end configured to sealingly connect to the oil breather pipe of the IC engine and an outlet end in communication with the inlet end and configured to sealingly connect to the air inlet tube, the oil breather pipe fitting configured for transferring humid air from the interior of the IC engine to the dehydrator.

17. The system of claim 1, comprising:
an oil filler fitting comprising:
a base configured to sealingly connect to an oil filler port of the IC engine;
an inlet connected to the base, the inlet is configured to sealingly connect to the air outlet tube, the inlet defines a first air passage through the inlet in communication with the air outlet tube;
a constrictor positioned along the first air passage, the constrictor defining a second air passage smaller than the first air passage and configured to increase a velocity of the dehumidified air received from the air outlet tube; and
an elongate down tube having a first end engaged with the base and a second end configured to be positioned proximate a reservoir oil level in an oil sump of the IC engine for transfer of the dehumidified air to the oil sump of the IC engine.

18. The system of claim 1, further comprising:
an exhaust fitting comprising:
a base configured to sealingly engage the exhaust pipe;
an inlet connected to the base, the inlet is configured to sealingly connect to the air outlet tube, the inlet defines a first air passage through the inlet in communication with the air outlet tube; and
a constrictor positioned along the first air passage, the constrictor defining a second air passage smaller than the first air passage and configured to increase a velocity of the dehumidified air received from the air outlet tube for transfer of the dehumidified air to cylinders of the IC engine.

19. The system of claim 1, further comprising:
an oil breather pipe fitting comprising:
a body having an outer wall defining an air passage;
an inlet end in communication with the air passage and having a seal configured to sealingly engage the oil breather pipe;
an outlet end in communication with the air passage and configured to sealingly connect with the air inlet tube;
a drain outlet in communication with the air passage and extending downward from the outer wall; and
a bottle sealingly removably connected to the drain outlet and configured to receive and store liquid oil received from the IC engine through the oil breather pipe.

20. The system of claim 1, further comprising:
an oil particulate filter positioned in communication with the air inlet tube, comprising:
a body defining a cavity configured to receive the humid air from the IC engine;
an inlet cap sealingly connected to the body upstream of the cavity;
an outlet cap sealingly connected to the body downstream of the cavity; and
a filter positioned in the cavity transverse to a flow of the humid air received from the IC engine through the cavity of the body, the filter configured to capture and retain liquid oil particulate in the humid air upstream of the air inlet of the dehydrator.

21. A sealed dehumidification system for removing humidity from an interior of an internal combustion engine (IC engine) of an aircraft at rest, the system comprising:
a dehydrator comprising:
a case defining an interior, the case having an air inlet and an air outlet defining an air pathway through the interior of the case between the air inlet and the air outlet;
a dryer cartridge positioned in the interior of the case in communication with the air pathway configured to remove the humidity from humid air in the air pathway and exit dehumidified air from the dryer cartridge, the dryer cartridge including dryer media;
a first fan having a fan speed and positioned in the interior of the case upstream of the dryer cartridge and in communication with the air pathway; and
a second fan having a fan speed positioned in the interior of the case downstream of the dryer cartridge and in communication with the air pathway;
an air inlet tube configured to sealingly connect to an oil breather pipe of the IC engine and to sealingly connect to the air inlet of the case;
an air outlet tube configured to sealingly connect to the air outlet of the case and to sealingly connect to an oil filler port and an exhaust pipe of the IC engine;
an oil filler fitting configured to sealingly connect to the oil filler port and the air outlet tube, the oil filler fitting comprising:
a constrictor configured to increase a velocity of the dehumidified air received from the dehydrator and transferred through the oil filler port; and
an elongate down tube extending proximate to a reservoir oil level in an oil sump of the IC engine configured to transfer the dehumidified air directly to the oil sump of the IC engine;
an exhaust fitting configured to sealingly connect to the air outlet tube and sealingly engage the exhaust pipe, the exhaust fitting including a constrictor configured to increase a velocity of the dehumidified air received from the dehydrator and transferred through the exhaust pipe and into cylinders of the IC engine; and
an oil breather pipe fitting configured to sealing connect to the air inlet tube and sealing engage the oil breather pipe of the IC engine, the oil breather pipe fitting including a bottle configured to receive and store liquid oil received from the IC engine through the oil breather pipe, the oil breather pipe fitting configured to transfer humid air from the interior of the IC engine to the dehydrator while preventing ambient air from being drawn into the dehydrator from an environment surrounding the dehydrator,
wherein the first fan and the second fan are configured to draw the humid air from the interior of the IC engine through the oil breather pipe, through the air inlet tube, through the air inlet of the case, into the air pathway in the interior of the case and through the dryer cartridge, and force the dehumidified air received from the dryer cartridge through the air outlet of the case, through the air outlet tube, to the oil filler fitting and the exhaust pipe fitting forming the sealed dehumidification system wherein the ambient air is prevented from being drawn into the dehydrator from the environment surrounding the dehydrator.

22. The system of claim 21, comprising:
a first humidity sensor positioned upstream of the dryer cartridge, the first humidity sensor configured to measure a humidity of the humid air received from the interior of the IC engine,
a second humidity sensor positioned downstream of the dryer cartridge, the second humidity sensor configured to measure a humidity of the dehumidified air received from the dryer cartridge
a controller in communication with the first humidity sensor, the second humidity sensor, the first fan, and the second fan, the controller configured to monitor signals respectively received from the first humidity sensor and the second humidity sensor, compare the signals respectively received to predetermined values, and energize, deenergize, increase the fan speed, or decrease the fan speed of the first fan and the second fan, based on the humidity as measured by the first humidity sensor and the second humidity sensor.

23. A method of dehumidifying an interior of an internal combustion engine (IC engine) at rest, the method comprising:
sealingly connecting an air inlet tube to an oil breather pipe of the IC engine and to an air inlet of a dehydrator;
sealingly connecting an air outlet tube to an oil filler port of the IC engine, an exhaust pipe of the IC engine, and an air outlet of the dehydrator;
forcibly drawing humid air by at least one fan connected to the dehydrator from the interior of the IC engine through the air inlet tube into an interior of the dehydrator preventing ambient air from an environment surrounding the dehydrator from entering the dehydrator;
transferring by the at least one fan the humid air along an air pathway in the interior of the dehydrator though a dryer cartridge having dryer media;
removing humidity from the humid air passing through the dryer cartridge;
exiting dehumidified air along the air pathway through the air outlet of the dehydrator; and
transferring by the at least one fan the dehumidified air through the air outlet tube to the interior of the IC engine through the oil filler port and the exhaust pipe.

24. The method of claim 23, wherein transferring the dehumidified air to the interior of the IC engine comprises:
transferring the dehumidified air through the oil filler port directly to an oil sump of the IC engine; and
transferring the dehumidified air through the exhaust pipe directly to cylinders of the IC engine.

25. The method of claim 23, comprising:
measuring by a first sensor positioned upstream of the dryer cartridge at least one of humidity, temperature, airflow, air pressure, a fan speed of the at least one fan, or energy consumption by the at least one fan;
measuring by a second sensor positioned downstream of the dryer cartridge at least one of humidity, temperature, airflow, air pressure, the fan speed of the at least one fan, or energy consumption by the at least one fan;
comparing by a controller in communication with the first sensor, the second sensor, and the at least one fan, signals received respectively from the first sensor and the second sensor to predetermined values; and
adjusting operation of the dehydrator based on the signals respectively received.

26. The method of claim 25, wherein the first sensor comprises a first humidity sensor configured to measure a humidity of the humid air received from the interior of the IC engine and the second sensor comprises a second humidity sensor configured to measure the humidity of the dehumidified air received from the dryer cartridge,
wherein adjusting the operation of the dehydrator comprises at least one of energizing, deenergizing, increasing the fan speed, or decreasing the fan speed of the at least one fan based on the humidity as measured by at least one of the first humidity sensor or the second humidity sensor.

27. The method of claim 26, comprising:
comparing by the controller the humidity as measured by the first humidity sensor to the humidity as measured by the second humidity sensor and calculating a differential humidity to monitor an effectiveness of the dryer media in removing the humidity from the humid air received from the interior of the IC engine; and
deenergizing the at least one fan by the controller when the differential humidity falls below a predetermined value indicative of a condition that the dryer media is saturated.
